(19) United States
(12) Patent Application Publication
(10) Pub. No.: US 2011/0058578 A9
(43) Pub. Date: Mar. 10, 2011

(54) LASER AND A METHOD FOR OPERATING THE LASER

(75) Inventors: Hamish Ogilvy, New South Wales (AU); Richard Paul Mildren, New South Wales (AU)

(73) Assignee: LIGHTHOUSE TECHNOLOGIES PTY LTD, New South Wales (AU)

(21) Appl. No.: 12/282,804

(22) PCT Filed: Mar. 13, 2007
(86) PCT No.: PCT/AU07/00309

§ 371 Date: Mar. 2, 2009

(30) Foreign Application Priority Data
Mar. 13, 2006 (AU) 2006901269

(51) Int. Cl. H01S 3/098; H01S 3/108; H01S 3/10

(52) U.S. Cl. 372/19; 372/21; 372/23; 372/105

(57) ABSTRACT

A laser comprising: a resonator cavity defined by at least two reflectors, wherein the at least two reflectors are highly reflective at a plurality of fundamental wavelengths; a laser medium disposed in the resonator cavity capable of generating plurality of fundamental wavelengths; an optical pump source for energizing the laser medium, thereby causing laser light at the plurality of fundamental wavelengths to resonate in the resonator cavity simultaneously; and a nonlinear material located in said resonator cavity capable of simultaneously converting each of the plurality of wavelengths of laser light to generate converted laser light having a plurality of converted wavelengths, said converted wavelengths being derived from but different to the fundamental wavelengths; wherein the non-linear material is at least partially phase matched to nonlinearly convert the frequencies of each of the fundamental wavelengths simultaneously such that a plurality of converted wavelengths are able to be simultaneously generated.

### TECHNICAL FIELD

The invention relates to a laser for generating visible output and a method for operating the laser. The invention has been developed primarily for use as a laser for generating visible output with high energy and a method for operating the laser at such high energy and high average power without causing damage to components of the laser.

### BACKGROUND

Many laser media are capable of generating multiple wavelengths of laser radiation. Although one of these wavelengths may predominate, in certain circumstances, such as when the laser radiation produced by the laser medium is subjected to a loss mechanism, such as second harmonic generation (SHG), a reduction in laser gain of the predominant wavelength (due to loss through the SHG process) can allow other wavelengths (parasitic wavelengths) to oscillate. The gain experienced by these parasitic wavelengths is often very low due to strong competition from the main wavelength, however, there is also very little loss as the SHG phase matching condition may be specific for the predominant wavelength. Due to this low loss condition, and when pumping the laser medium strongly, the parasitic wavelengths can grow in amplitude as they ‘steal’ population inversion from the main wavelength, which depletes the second harmonic with a severe risk of causing damage to components in the laser resonator.

This problem has been addressed in the past by use of an etalon to suppress the parasitic wavelengths. However it is difficult to use an etalon when operating with multiple wavelengths simultaneously. Additionally, an etalon attenuates the output from the laser, making it more difficult to achieve high output energies. Etalons are also sensitive to temperature and any angular displacement, so their inclusion also reduces the robustness of the system. They require careful positioning in the laser cavity in order to operate effectively, and add to the cost of a laser system. The arrangements of the laser system described herein provides an alternative approach to avoiding damage due to parasitic wavelengths in the resonator, particularly in systems which are capable of generating high power output.

### SUMMARY

The laser system of the arrangements described herein may comprise a resonator cavity defined by at least two reflectors, wherein the two reflectors are highly reflective at a plurality of fundamental wavelengths. The laser system may further comprise a laser medium disposed in the resonator cavity capable of generating plurality of fundamental wavelengths. The laser system may further comprise an optical pump source for energizing the laser medium, thereby causing laser light at the plurality of fundamental wavelengths to resonate in the resonator cavity simultaneously. The laser system may still further comprise a nonlinear material located in said resonator cavity capable of simultaneously converting each of the plurality of wavelengths of laser light to generate converted laser light having a plurality of converted wavelengths, said converted wavelengths being derived from but different to the fundamental wavelengths. The non-linear material may be at least partially phase matched to convert each of the fundamental wavelengths simultaneously.

In an arrangement of a first aspect, there is provided a laser comprising a resonator cavity defined by at least two reflectors, wherein the at least two reflectors are highly reflective at a plurality of fundamental wavelengths;
a laser medium disposed in the resonator cavity capable of generating plurality of fundamental wavelengths;
an optical pump source for energizing the laser medium, thereby causing laser light at the plurality of fundamental wavelengths to resonate in the resonator cavity simultaneously; and
a nonlinear material located in said resonator cavity capable of simultaneously converting each of the plurality of wavelengths of laser light to generate converted laser light having a plurality of converted wavelengths, said converted wavelengths being derived from but different to the fundamental wavelengths;
wherein the non-linear material is at least partially phase matched to convert each of the fundamental wavelengths simultaneously.

In a second arrangement of the first aspect, there is provided a laser comprising a resonator cavity defined by at least two reflectors, wherein the two reflectors are highly reflective at a plurality of fundamental wavelengths;
a laser medium disposed in the resonator cavity capable of generating plurality of fundamental wavelengths, comprising a primary fundamental wavelength and at least one parasitic fundamental wavelength;
an optical pump source for energizing the laser medium, thereby causing laser light at the primary fundamental wavelength and the at least one parasitic fundamental wavelength to resonate in the resonator cavity simultaneously; and
a nonlinear material located in said resonator cavity capable of simultaneously converting the primary fundamental wavelength and the at least one parasitic fundamental wavelength to generate converted laser light having a plurality of converted wavelengths, the converted wavelengths being derived from but different to the fundamental wavelengths and comprising a primary converted wavelength derived from the primary fundamental wavelength and at least one parasitic converted wavelength derived from the at least one parasitic wavelength;
wherein the non-linear material is at least partially phase matched to convert the primary fundamental wavelength and the at least one parasitic fundamental wavelengths simultaneously.

The primary converted wavelength may be output from the laser cavity. The primary converted wavelength may be output from the laser cavity via an output coupler. The primary converted wavelength only may be output from the laser cavity and the parasitic converted wavelengths may not be outputted from the laser cavity. The parasitic fundamental wavelengths may or may not be outputted from the laser cavity. The converted parasitic wavelengths may have a lower optical power than the primary converted wavelengths. The parasitic wavelengths may be a band of wavelengths. The parasitic wavelengths may be a narrow band of wavelengths. The band of parasitic fundamental wavelengths may be within a range approximately 0.5 to 15 nm, or the band of parasitic fundamental wavelengths may be within a range of approximately 0.5 to 10, 0.5 to 8, 0.5 to 7, 0.5 to 6, 0.5 to 5, 0.5 to 4, 0.5 to 3, 0.5 to 2, 0.5 to 1, 1 to 5, to 4, 1 to 3, or 1 to 2 nm.

The laser may further comprise an output coupler disposed so as to output the converted laser light as output laser light.

The plurality of fundamental wavelengths converted by the nonlinear material may be sufficiently close in wavelength that the nonlinear material can be phase matched to them simultaneously so as to convert them into the converted wavelengths simultaneously. The phase matching of one or more of the fundamental wavelengths may be suboptimal. The phase matching of each of the fundamental wavelengths that resonate within the cavity may be sufficient that the conversion by the nonlinear material is such that all but a selected one of the fundamental wavelengths can build up within the cavity to a level at which damage is caused to a component of the laser.

At least one of the reflectors may be transmissive at fundamental wavelengths of laser light that are not converted by the nonlinear material so that those fundamental wavelengths do not resonate within the cavity.

The nonlinear material may be configured for either Type I phase-matching, Type II phase-matching or quasi-phasematching. The nonlinear material may comprise a frequency doubler or a sum frequency generator or a frequency doubler and a sum frequency generator.

The laser may further comprise a compensator located in the resonator cavity for reducing thermally induced depolarisation of the laser light. The compensator may be located intermediate the laser material and one of the reflectors. The compensator may be selected from the group of a birefringent waveplate, or a faraday rotator. The birefringent waveplate may be either a quarter-wave plate or a half-wave plate. The compensator may be a combination of a porro-prism and a birefringent waveplate and or an optical rotator.

The plurality of fundamental wavelengths may be polarised. The laser may further comprise a polariser located in the resonator cavity for polarising the laser light resonating in the cavity.

The laser may be a pulsed laser. The laser may further comprise an intracavity Q-switch for generation of the laser pulses. The laser may alternately comprises mode locker for generation of the laser pulses. The laser pulses may be generated in a burst of a plurality of laser pulses.

The laser may further comprise a power supply for energizing the optical pump source. The power supply may be capable of being operated in such a way that the output light is provided in repeated bursts of output pulses. The bursts may be repeated at a burst-repetition rate between about 0.1 Hz and about 20 Hz. The laser energy in each burst of output pulses may be greater than 3 Joules. The laser energy in each burst of output pulses may be greater than 5 Joules. The duration of each burst of pulses may be between 1 and 200 milliseconds. The duration of each burst of pulses may alternately be between 1 and 100 milliseconds. The duration of each burst of pulses may alternately be between about 50 and 100 milliseconds. The duration of each burst of pulses may be less than 100 milliseconds.

The laser may be a solid state laser. The laser material may be a solid state laser material comprising a neodymium active ion for generation of the plurality of fundamental wavelengths. The laser material may be selected from the group of Nd:YAP, Nd:YLF, Nd:YAG, Nd:YALO, Nd:YAP, Nd:GdVO₄ and Nd:YVO₄. The nonlinear material may be selected from the group of LBO, BBO, KTP, CLBO, DLAP, ADP, periodically poled lithium niobate, periodically poled KTP, periodically poled KTA, and periodically poled RTA. The laser material may be Nd:YAG and the nonlinear material may be LBO. The laser material may be a solid state material comprising an active ion for generation of the plurality of fundamental wavelengths, wherein the active ion has a continuously tunable emission transition. The tunable emission bandwidth of the active ion may be greater than 1 nm and may be in the range of 1 to 100 nm, or 1 to 80 nm, 1 to 70 nm, 1 to 60, 1 to 50, 1 to 40, 1 to 30, 1 to 20, 1 to 15, 1 to 10, or 1 to 5 nm. The active ion may be selected from the group of chromium, titanium, erbium, holmium, thulium, nickel, cobalt, vanadium, cerium and ytterbium.

The output coupler may transmissive at least at a wavelength of 532 nm and the output laser light may be at a wavelength of 532 nm. The output coupler may be transmissive at least at a wavelength of 660 to 670 nm and the output laser light may be substantially comprised of light at wavelengths of 660 nm, 665 nm and 670 nm. One of the reflectors defining the laser cavity may act as an output coupler.

The laser may further comprise a tuner for tuning the nonlinear material so as to be capable of converting the plurality of wavelengths of the laser light to generate output laser light having the converted wavelength of laser light. The laser may additionally comprise a temperature controller for controlling the temperature of the nonlinear medium.

The laser may further comprise a third reflector located in the resonator cavity, wherein the resonator cavity is a folded resonator cavity and the third reflector is a folding reflector. The folding reflector may be an output coupler for outputting at least one of the converted wavelengths.

In a second aspect there is provided a laser comprising: a resonator cavity defined by at least two reflectors, wherein the at least two reflectors are highly reflective at a plurality of fundamental wavelengths; a laser medium disposed in the resonator cavity capable of generating plurality of polarised beams at the fundamental wavelengths; an optical pump source for energizing the laser medium, thereby causing laser light at the plurality of fundamental wavelengths to resonate in the resonator cavity simultaneously; a nonlinear material located in said resonator cavity capable of simultaneously converting each of the plurality of wavelengths of laser light to generate converted laser light having a plurality of converted wavelengths, said converted wavelengths being derived from but different to the fundamental wavelengths; and a polarisation compensation element located in the resonator cavity for depolarisation compensation of the polarised beams due to thermal heating of either the laser medium or the nonlinear medium.

The compensator may be selected from the group of a quarter-wave plate, a half-wave plate, or some other birefringent waveplate, or a faraday rotator. The compensator may be a combination of a birefringent waveplate and a porro-prism.

In a third aspect, there is provided a laser comprising: a resonator cavity defined by at least two reflectors, wherein the at least two reflectors are highly reflective at a plurality of fundamental wavelengths; a laser medium disposed in the resonator cavity capable of generating plurality fundamental wavelengths; an optical pump source for energizing the laser medium, thereby causing laser light at the plurality of fundamental wavelengths to resonate in the resonator cavity simultaneously; and a nonlinear material located in said resonator cavity capable of simultaneously converting each of the plurality of wavelengths of laser light to generate converted laser light having a plurality of converted wavelengths, said converted wavelengths being derived from but different to the fundamental wavelengths; wherein the nonlinear medium is capable of either frequency converting the plurality of fundamental wavelengths or providing sufficient loss at the fundamental wavelengths to prevent unwanted fundamental wavelengths from oscillating in the resonator cavity.

In a fourth aspect, there is provided a method for providing laser light comprising: providing a laser as claimed in any one of the first through third aspects; causing the optical pump to energise the laser medium, thereby causing laser light at a plurality of fundamental wavelengths to circulate in the resonator cavity; allowing the nonlinear material to simultaneously convert the plurality of wavelengths of the laser light to create output laser light having the converted wavelengths; and outputting the output laser light from the laser.

The method may additionally comprise tuning the nonlinear material so as to be capable of converting the plurality of wavelengths of the laser light to create the output light having a plurality of converted wavelengths of laser light, said converted wavelengths being different from the fundamental wavelengths.

The nonlinear material may be either Type I phasematched, Type II phasematched, or quasi-phasematched. The tuning may comprise angle tuning or temperature tuning.

The method may further comprise polarising the laser light circulating in the resonator cavity.

The step of causing the optical pump to energise the laser medium may comprise causing the optical pump to energise the laser medium such that the laser medium generates polarised laser light at a plurality of fundamental wavelengths which resonate in the resonator cavity.

The method may additionally comprise compensating for thermally-induced depolarisation of the laser light using a compensator.

The plurality of fundamental wavelengths converted by the nonlinear material may be sufficiently close in wavelength that the nonlinear material can be phase matched to them simultaneously so as to convert them into the converted wavelengths simultaneously. The phase matching of one or more of the fundamental wavelengths may be suboptimal. The phase matching of each of the fundamental wavelengths that resonate within the cavity may be sufficient that the conversion by the nonlinear material may be such that all but a selected one of said fundamental wavelengths can build up within the cavity to a level at which damage is caused to a component of the laser.

At least one of the reflectors may be transmissive at fundamental wavelengths of laser light that are not converted by the nonlinear material so that those fundamental wavelengths do not resonate within the cavity.

In a fifth aspect, there is provided a method of using a laser according to any one of the first through third aspects for treating, detecting or diagnosing a selected area on or in a subject requiring such diagnosis or treatment, the method comprising illuminating the selected area with output light from the laser

In a sixth aspect, there is provided a method of using a laser according to any one of the first through third aspects for treating, detecting or diagnosing a selected area on the skin of a subject requiring such diagnosis or treatment, the method comprising illuminating the selected area with output light from the laser.

The method may comprise treating a skin condition selected selected from the group of tattoo removal or reduction, hair removal or reduction, skin rejuvenation, skin tightening, treatment of vascular lesions, rosacea, removal of port wine stains, varicose vein removal, removal of pigmented lesions, removal or reduction of scars or keloids, cellulite removal or reduction, psoriasis, vitiligo, autoimmune disease, eczema, acne, actinic keratoses, skin cancer.

The method may comprise treating a condition selected from the group of benign prostate hyperplasia, atrial fibrillation, opthalmology, clot removal, and removal (vaporization) of tissue.

In a seventh aspect, there is provided a method of using a laser according to any one of the first through third aspects when used for treating, detecting or diagnosing a selected area requiring such diagnosis or treatment on or in a subject.

The laser may be used for treating, detecting or diagnosing a selected area on the skin of a subject requiring such diagnosis or treatment.

In a eighth aspect there is provided a laser, comprising:
a resonator cavity defined by at least two reflectors;
a laser medium disposed in the resonator cavity;
an optical pump source for energizing said laser medium, thereby causing laser light at a plurality of fundamental wavelengths to circulate in said resonator cavity; and
a nonlinear material located in said resonator cavity for simultaneously converting the plurality of wavelengths of the laser light to generate converted laser light having a plurality of converted wavelengths, said converted wavelengths being different from the fundamental wavelengths;
   wherein the non-linear material is type I or type II phase matched or quasi phase matched to the fundamental wavelengths and the converted wavelengths.

In a ninth aspect there is provided a laser comprising:
a resonator cavity defined by at least two reflectors, wherein the two reflectors are highly reflective at a plurality of fundamental wavelengths;
a laser medium disposed in the resonator cavity capable of generating a plurality of fundamental wavelengths;
an optical pump source for energizing the laser medium, thereby causing laser light at the plurality of fundamental wavelengths to resonate in the resonator cavity simultaneously; and
a nonlinear material located in said resonator cavity capable of simultaneously converting each of the plurality of wavelengths of laser light to generate converted laser light having a plurality of converted wavelengths, said converted wavelengths being derived from but different to the fundamental wavelengths;
wherein the non-linear material is at least partially phase matched to convert each of the fundamental wavelengths simultaneously.

All or some of the components of the laser may be intracavity. The laser may be an intracavity wavelength converted laser. The plurality of fundamental wavelengths converted by the nonlinear material may be sufficiently close in wavelength that the nonlinear material can be phase matched to them simultaneously so as to convert them into the converted wavelengths simultaneously. The phase matching of one or more of the fundamental wavelengths may be suboptimal. Thus the nonlinear material may not be perfectly matched to all of the fundamental wavelengths that resonate in the cavity. The phase matching of each of the fundamental wavelengths that resonate within the cavity may be sufficient that the conversion by the nonlinear material is such that none of said fundamental wavelengths can build up within the cavity to a level at which damage is caused to a component (e.g. the laser medium and/or the nonlinear material and/or the reflectors or mirrors of the cavity, and/or any other optical elements located in the cavity for example etalons, prisms, polarisers, depolarisers, q-switches, modelockers, lenses, gratings, beamsplitters etc) of the laser. The plurality of fundamental wavelengths may comprise a primary fundamental wavelength and at least one parasitic fundamental wavelength and the phase matching of each of the fundamental wavelengths that resonate within the cavity is sufficient that the conversion by the nonlinear material is such that the parasitic fundamental wavelengths can not build up within the cavity to a level at which damage is caused to a component of the laser. The plurality of fundamental wavelengths may be generated by the laser medium with similar gain, e.g. with gain within about 1, 2, 3, 4, 5, 6, 7, 8, 9, 10, 12, 15, 17, 20, 25, 30 or 35%. The plurality of fundamental wavelengths resonate within the cavity simultaneously.

The laser medium may also generate one or more parasitic fundamental wavelengths of laser light that are not converted by the nonlinear material. These may have sufficiently different wavelength to the fundamental wavelengths that they are not converted. They may be generated at a gain of less than about 90, 80, 70, 60 or 50% of the gain of a fundamental wavelength that is converted by the nonlinear medium. The fundamental wavelengths that are not converted may not resonate within the cavity. For example at least one of the reflectors that define the cavity may be sufficiently transmissive towards these fundamental wavelengths that they are incapable of resonating with the cavity. The nonlinear coupling coefficient at the parasitic wavelengths may provide enough loss on these transitions to either convert or suppress them almost completely.

The wavelength conversion may comprise frequency doubling or sum frequency generation. For example for fundamental wavelengths of 1320 and 1340 nm, wavelength conversion may generate 660 and 670 nm by frequency doubling, and 665 nm from sum frequency generation.

The laser may comprise an output coupler disposed so as to output the converted laser light as output laser light. The non-linear material may be type I phase matched and not type II phase matched. The non-linear material may be type II phase matched and not type I phase matched. The non-linear material may be both type I and type II phase matched (an example nonlinear material capable of simultaneous Type I and Type II phase-matching is PPKTP) The laser may be a pulsed laser. Either or both of the laser medium and the nonlinear material may be solids. Either or both may be crystals. The laser may be a solid state laser. The optical pump may be a flashlamp pump, a diode laser pump or some other suitable pump capable of energising (pumping) the laser medium and thereby causing the laser medium to generate laser light at a plurality of fundamental wavelengths. The nonlinear material may be an optically nonlinear material. It may be a frequency doubler (second harmonic generator) or a sum frequency generator or some other type of nonlinear material. The laser light generated by the laser medium may circulate (resonate) in the cavity in more than one longitudinal mode. The plurality of fundamental wavelengths generated by the laser medium may be sufficiently close that the nonlinear material is capable of converting the plurality of fundamental wavelengths simultaneously to generate the output laser light. The laser medium may be a neodymium-doped laser medium, e.g. Nd:YAG. The laser may be operated without causing damage to components thereof. The plurality fundamental wavelengths may be polarised. They may all be polarised in the same plane. The converted wavelengths may be polarised. They may all be polarised in the same plane. They may be polarised orthogonally with respect to the fundamental wavelengths. The nonlinear medium, in converting the fundamental wavelengths to the converted wavelengths, may rotate the plane of polarisation of the laser light i.e. the converting may comprise an o+o=e conversion (type I phase matching) (e.g. frequency doubling, trebling, summing or differencing). There may be a single nonlinear material, e.g. nonlinear crystal, within the cavity. There may be a single laser medium, e.g. laser crystal or laser rod, within the cavity.

The laser may comprise a tuner for tuning the nonlinear material so as to be capable of converting the plurality of wavelengths of the laser light to generate output laser light having the converted wavelength of laser light. The tuning may comprise angle tuning or temperature tuning. The converting may be second harmonic generation (SHG) or sum frequency generation (SFG), both SHG and SFG simultaneously, or some other type of wavelength converting. The laser may also comprise a temperature controller for controlling the temperature of the nonlinear medium. The temperature controller may be a temperature tuner.

The laser may comprise a power supply for energizing the optical pump. The power supply may be capable of being operated in such a way that the output light is provided in repeated bursts of output pulses. The bursts may be repeated at a burst-repetition rate between about 0.1 Hz and about 20 Hz, each of said bursts having a duration greater than about 3 milliseconds. The burst repetition rate may be less than 0.1 Hz, and may be a single shot burst. Each burst may comprise two or more output-pulses having a duration of about 0.1 to about 50 milliseconds. The total energy of the output pulses in each burst may be greater than the total energy of a single output pulse having a duration as long as the burst. The laser may comprise a Q-switch. The Q-switch may be an active or a passive Q-switch. It may be used for converting the laser light circulating in the cavity to pulsed laser light, particularly to high peak power pulsed laser light. The Q-switch, if present, should be an intracavity Q-switch. The laser may comprise a mode locker. The mode locker may be an active mode locker or a passive mode locker.

The laser may also comprise a compensator. The compensator may compensate to remove any thermally induced depolarisation of the laser light. The thermal depolarisation may be due to thermally induced stress birefringence in the laser medium. The compensator may comprise a quarter wave plate. The compensator may comprise a faraday rotator. The compensator may be located between the laser medium and one of the reflectors. In some arrangements, one of the reflectors that define the cavity is a porro prism, and the compensator is an optical rotator. Suitably, in such arrangements the optical rotator is positioned between the porro prism and the laser medium. The laser light resonating in the cavity may be polarised. The laser may comprise a polariser for polarising the laser light resonating in the cavity. The polariser may be an intracavity polariser. The intracavity polariser may comprise a Brewster plate or some other type of polariser. Alternatively, the optical pump may be capable of generating polarised pump radiation for pumping the laser medium in order to generate polarised laser light which can resonate in the cavity. The laser may have no etalon.

The laser may comprise an output coupler, or one of the reflectors defining the laser cavity may act as an output coupler. For example one of the reflectors may have a coating that is highly reflective towards the fundamental wavelengths and highly transmissive towards the converted wavelengths, and may function as an output coupler. In this case, the other reflectors may be highly reflective towards the converted wavelengths so that only a single output laser beam is outputted from the laser. One of the reflectors may be transmissive towards the wavelength of pump radiation generated by the optical pump, to enable end pumping of the laser medium. If the laser medium is side pumped, there is no requirement for any of the reflectors to transmit the pump radiation. One or more of the reflectors may be transmissive (optionally highly transmissive) towards fundamental wavelengths generated by the laser medium that can not be converted by the nonlinear material for the chosen non linear phase-matching condition.

In a tenth aspect there is provided a method for providing laser light comprising:
providing a laser according to the eighth aspect;
causing the pump source to energise the laser medium, thereby causing laser light at a plurality of fundamental wavelengths to circulate in the resonator cavity;
optionally tuning the nonlinear material so as to be capable of converting the plurality of wavelengths of the laser light to create output light having a plurality of converted wavelengths of laser light, said converted wavelengths being different from the fundamental wavelengths;
allowing the nonlinear material to convert the plurality of wavelengths of the laser light to create output laser light having the converted wavelengths; and
outputting the output laser light from the laser.

In a eleventh aspect, there is provided a method for providing laser light comprising:
providing a laser, said laser comprising a resonator cavity defined by at least two reflectors each highly reflector being highly reflective at a plurality of fundamental wavelengths and transmissive at a plurality of converted wavelengths, a laser medium disposed in the resonator cavity capable of generating a plurality of fundamental wavelengths; an optical pump for energizing said laser medium thereby causing laser light at a plurality of fundamental wavelengths to circulate in said resonator cavity, and a nonlinear material located in said resonator cavity for simultaneously converting the plurality of wavelengths of the laser light to generate converted laser light having a plurality of converted wavelengths, said converted wavelengths being different to but derived from the fundamental wavelengths, wherein the non-linear material is type I or type II or quasi phase matched to frequency convert the fundamental wavelengths to the converted wavelengths;
causing the optical pump to energise the laser medium, thereby causing laser light at a plurality of fundamental wavelengths to circulate in the resonator cavity;
allowing the nonlinear material to simultaneously convert the plurality of wavelengths of the laser light to create output laser light having the converted wavelengths; and
outputting the output laser light from the laser.

According to a twelfth aspect there is provided a method of using the laser of either the eighth or the ninth aspects for treating, detecting or diagnosing a selected area on or in a subject requiring such diagnosis or treatment, said method comprising illuminating the selected area with output light from said laser. The selected area may be illuminated with output light having a wavelength, or wavelengths, and for a time and at a power level, which is (are) appropriate and effective for the diagnosis or therapeutically effective for the treatment. The subject may be a mammal or vertebrate or other animal or insect, or fish. The method may find application in treating the eyes and skin of a mammal or vertebrate. The laser system may be a solid-state laser system.

According to a thirteenth aspect, there is provided a method of using the laser of either the first or the second aspects laser for treating, detecting or diagnosing a selected area requiring such diagnosis or treatment on or in a subject.

### BRIEF DESCRIPTION OF THE DRAWINGS

Arrangements of the laser systems will now be described by way of example with reference to the accompanying drawings wherein:

FIG. 1A shows a graph of the nonlinear coupling efficiency of LBO and KTP at 1064 nm;

FIG. 1B shows a KTP and LBO angular phase matching comparison at 300K;

FIG. 2 is a graph illustrating non-critical phase matching in LBO;

FIG. 3A is a graph illustrating critical phase matching in LBO;

FIG. 3B is a graph illustrating the variation in phase matching with temperature in LBO;

FIG. 4 is a diagrammatic representation of an arrangement of the laser system;

FIG. 5 is a diagrammatic representation of a straight cavity arrangement of the laser system;

FIG. 6 is a diagrammatic representation of the laser described in Example 1;

FIG. 7 shows the output characteristics of the laser of Example 1;

FIG. 8 shows a spectral output from the laser of Example 1; and

FIG. 9 is a diagrammatic representation of the laser described in Example 2;

FIG. 10 shows the output characteristics of the laser of Example 2;

FIG. 11 shows a spectral output from the laser of Example 2; and

FIG. 12 a temporal trace of the two 1.3 μm lines from Example 2.

### DETAILED DESCRIPTION

Arrangements of the laser systems disclosed herein relate to the use of nonlinear materials such as LBO for frequency doubling, whereby the non-linear materials are capable of converting not only the predominant wavelength generated by a laser medium but also potential parasitic transitions (wavelengths). These non-linear materials may be incorporated into a laser so as to reduce the chance of optically induced damage and to smooth amplitude instabilities. The arrangements of the laser systems have the advantage of having no requirement for wavelength selective components, such as intracavity etalons, prisms or gratings etc. The arrangements described are particularly applicable to lasers with high pulse energies, for example flashlamp pumped lasers, however may also be applied to low output power lasers such as diode pumped lasers.

For example Nd:YAG may be used as a laser medium in an arrangement of the present laser system, and second harmonic generation using LBO may be employed to suppress damage and instability caused by parasitic lasing of other neodymium transitions. Although 1064 nm is the wavelength of the predominant laser transition of the Nd:YAG laser, for certain cases, such as second harmonic generation (SHG), a reduction in laser gain of the 1064 nm transition (due to loss through the SHG process) can allow other transitions to oscillate. The gain experienced by these parasitic wavelengths is often very low due to strong competition from the main wavelength, however, there is also very little loss as the SHG phase matching condition may be specific for the predominant. Due to this low loss condition, and when pumping the laser medium strongly, the parasitic transitions can grow in amplitude as they ‘steal’ population inversion from the main transition, which both depletes the second harmonic with a severe risk of causing damage to components in the laser resonator. Thus LBO may be used as a frequency doubling material in arrangements of the laser system, as the type I 1064 nm phase matching condition covers not only the main transition, but also partially covers potential parasitic transitions, such as the 1061 nm line, thereby generating frequency doubled wavelengths of 532 and 530.5 nm which may be outputted. This reduces the chance of optically induced damage by providing an additional loss mechanism to the resonator cavity which provides sufficient loss at the wavelength(s) of the parasitic transitions so that they are prevented from growing appreciably. A further advantage of providing sufficient loss at the wavelength(s) of the parasitic transitions is that the amplitude instabilities in the output of the laser are smoothed and the requirement for wavelength selective components, such as intracavity etalons prisms or gratings etc, is alleviated.

Earlier systems directed at similar problems, have used an intracavity Etalon. In some arrangements the laser system uses a type I wavelength conversion process, which requires that the resonating laser beam to be doubled be polarised. Accordingly the arrangement uses a polariser and optionally a compensator (for compensating for thermal depolarisation of laser light within the laser medium) such as a quarter wave plate for reducing thermally induced depolarisation. The type I process is capable of producing second harmonic generation for multiple simultaneous transitions. This contrasts with the type II process used in earlier work in conjunction with an etalon, which used KTP as a nonlinear material. The earlier systems attempted to avoid multiple transitions in the case of SHG, as multiple transitions cause spiking and damage. In arrangements of the laser systems it is found that, by use of an appropriate nonlinear material, multiple transitions may resonate simultaneously without causing such problems, as they may be wavelength converted simultaneously. In some arrangements, the laser system may employ a type II wavelength conversion process. If a polariser is present in such systems, it should be oriented such that both e and o beams are capable of resonating in the cavity so that the type II process (o+e=o) is enabled. The orientation may be for example at 45° to the polarisations of both o and e beams.

The phase matching conditions for the pairs (1064, 1061 nm) and (1319, 1338 nm) are closer together for type I than type II for many common non-linear materials, therefore there is a greater chance of overlap between the two wavelengths in the type I process. This serves to limit damage due to resonating parasitic transitions.

Arrangements of the laser system are capable of providing bursts of output laser light, for example at a green or a red wavelength, where the energy in the burst is at least or greater than about 3 joules, or greater than about 4, 5, 6, 7, 8, 9 or 10 joules. The output energy in the burst may be between about 1 and about 35 J or between about 1 and 20, 20 and 35, 10 and 35, 8 and 35, 5 and 35, 5 and 20, 8 and 20, 10 and 20, 1 and 10 or 5 and 10 J, for example about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 J or more than 35 J.

The cavity of arrangements of the laser system may be any convenient configuration, for example a straight or linear cavity or a folded cavity or a Z cavity. The laser medium and the non-linear material may be in separate portions of the cavity.

### Nd:YAG Transitions

A list of the Nd:YAG laser transitions and their relative strength is shown in Table 1 below. The main parasitic transitions associated with the 1064 nm transition are 1061 nm and 1074 nm. These transitions are sufficiently close to 1064 nm such that ample loss (i.e. sufficient loss in the laser resonator such that the resonator gain at the wavelength of the parasitic laser transition is less than the loss at that wavelength) to prevent lasing cannot be induced by altering the resonator mirror transmissions. When frequency doubled, these are converted to 532, 530.5 and 537 nm laser radiation respectively, which may be outputted. Sum-frequency mixing of any two of these wavelengths may also occur generating wavelengths of 531.25, 534.5 and 533.75 nm, which also may be outputted.

TABLE 1
Main room-temperature transitions in Nd:YAG

| Wavelength | | | Frequency doubled |
|---|---|---|---|
| ([μm]) in air) | Transition | Relative Strength | wavelength (nm) |
| 1.06414 | R₂ → Y₃ | 100 | 532 |
| 1.06152 | R₁ → Y₁ | 92 | 531 |
| 1.0738 | R₁ → Y₃ | 65 | 537 |
| 1.0646 | R₁ → Y₂ | ≈50 | 532 |
| 1.1121 | R₂ → Y₆ | 49 | 556 |
| 1.05205 | R₂ → Y₁ | 46 | 526 |
| 1.1159 | R₁ → Y₅ | 46 | 558 |
| 1.12267 | R₁ → Y₆ | 40 | 561 |
| 1.0780 | R₁ → Y₄ | 34 | 539 |
| 1.3188 | R₂ → X₁ | 34 | 659 |
| 1.3382 | R₂ → X₃ | 24 | 669 |
| 1.3350 | R₁ → X₂ | 15 | 668 |
| 1.3564 | R₁ → X₄ | 14 | 678 |
| 1.3338 | R₁ → X₁ | 13 | 667 |
| 1.1054 | R₂ → Y₅ | 9 | 553 |
| 1.3200 | R₂ → X₂ | 9 | 660 |
| 1.3410 | R₂ → X₄ | 9 | 671 |
| 1.4140 | R₂ → X₆ | 1 | 707 |
| 1.4440 | R₁ → X₇ | 0.2 | 722 |

A description of LBO, including a comparison to other non-linear materials, can be found in S. P. Velsko, M. Webb, L. Davis, and C. Huang, “Phase-matched harmonic generation in lithium triborate (LBO)” Quantum Electronics, IEEE Journal of 27, 2182-2192 (1991). LBO is a physically strong material with good optical transmission and high damage threshold. It is also expensive, which has limited its deployment in commercial devices.

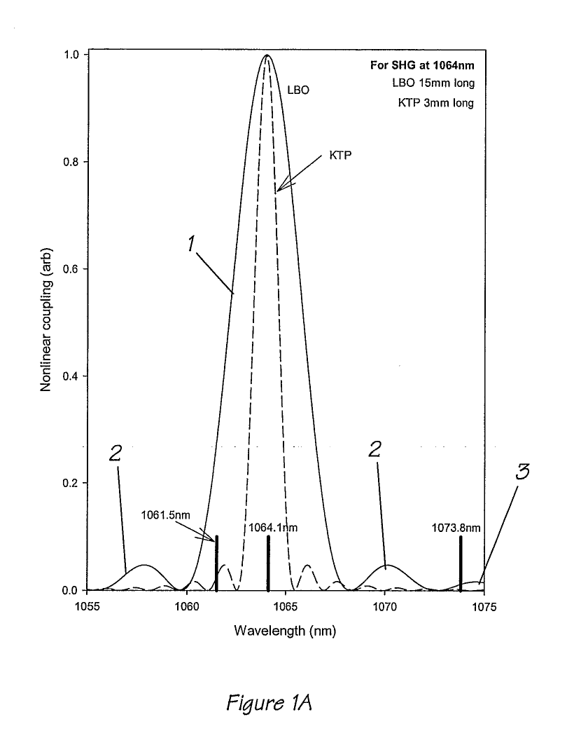

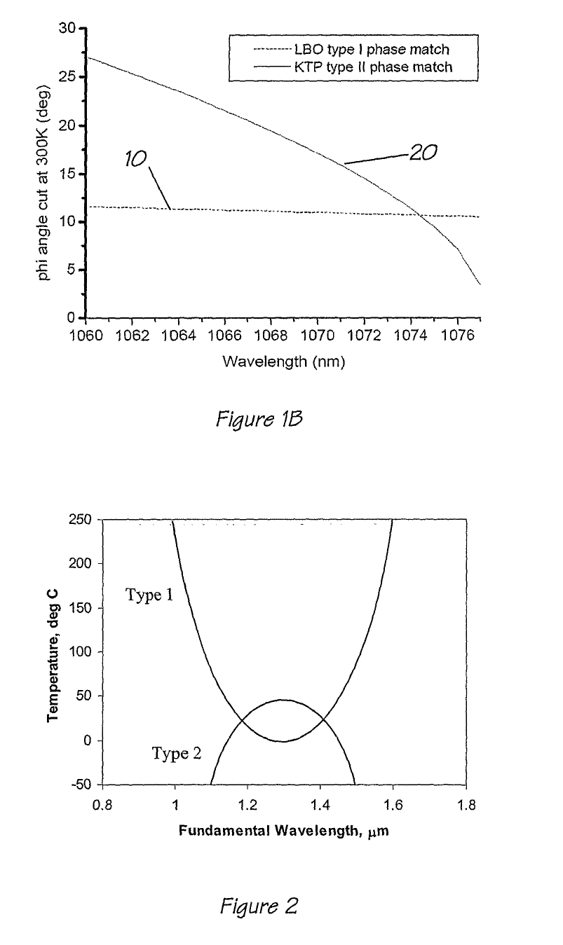

By contrast, KTP is the most common choice for SHG of 1064 nm lasers, due to its lower cost and high non-linear coefficient. However, the type II phase matching angle for 1064 nm is quite different to that of the parasitic 1061 and 1074 nm transitions and the wavelength acceptance range is more narrow. In contrast, the type I angular phase matching condition for LBO is very similar for 1064, 1061 and 1074 nm, and the wavelength acceptance is more broad. Wavelength acceptance is property of the nonlinear crystal that quantifies what range of wavelengths will be phasematched or partially phasematched where a wavelength which is partially phasematched refers to such a wavelength that lies within the phasematching bandwidth of the nonlinear material, although not at the peak. Partial phasematching of wavelengths not at the peak of the phasematching curve (such as wavelengths 1061.5 nm and 1073.8 nm in the example phasematching curves shown in FIG. 1A). Wavelengths that are sufficiently close so that they each coincide with those wavelengths phasematched by the nonlinear material (as defined by the phasematching curves) may be sufficiently partially phasematched so that they are converted by the nonlinear material and prevent the fundamental wavelength (which may be an unwanted parasitic wavelength) does not build up enough in the resonator cavity to cause damage to any of the optical components in the resonator cavity. Sufficient phase matching (i.e. the amount that a particular wavelength is partially phasematched) may be in the range of 2.5% to 97% of the peak phasematching efficiency of the nonlinear material (where the range of about 97% to 100% is defined as optimal phase matching efficiency). Alternatively, the partial phasematching may be in the range of about 2.5% to 97%, 2.5% to 96%, 2.5% to 95%, 2.5% to 90%, 2.5% to 85%, 2.5% to 80%, 2.5% to 75%, 2.5% to 70%, 2.5% to 65%, 2.5% to 60%, 2.5% to 55%, 2.5% to 50%, 2.5% to 45%, 2.5% to 40%, 2.5% to 40%, 2.5% to 35%, 2.5% to 30%, 2.5% to 25%, 2.5% to 20%, 2.5% to 15%, 2.5% to 10%, 2.5% to 5%, 5% to 97%, 5% to 95%, 5% to 90%, 5% to 90%, 5% to 80%, 5% to 70%, 5% to 60%, 5% to 50%, 5% to 40%, 10% to 97%, 10% to 90%, 10% to 80%, 10% to 70%, 10% to 60%, 10% to 50%, 10% to 40%, 10% to 30%, or 10% to 20% of the peak phasematching efficiency of the nonlinear material, and may be about 2.5%, 3%, 4%, 5%, 10%, 15%, 20%, 25%, 30%, 35%, 40%, 45%, 50%, 55%, 60%, 65%, 70%, 75%, 80%, 85%, 90%, 95%, 96% or 97% of the peak phasematching efficiency of the nonlinear material. At these phasematching efficiencies (i.e. less that about 97%), the phasematching may be defined as being suboptimal.

Using values in the literature for wavelength acceptance (eg. in the software package SNLO available from Sandia National Laboratories in Albuquerque), the wavelength acceptance for a 3 mm long KTP crystal is 3.0 nm whereas for a 15 mm long LBO crystal it is 5.7 nm. FIG. 1A shows a graph of how the calculated nonlinear coupling coefficient varies with wavelength for phasematching at 1064 nm for LBO (Type I phasematching) and KTP (Type II phasematching) crystals. It is clearly evident from the figure that the nonlinear coupling in LBO is many times higher than for KTP and over a broader range of wavelengths. It may also be possible to convert additional parasitic wavelengths by ensuring that they coincide with a secondary peak in the sinc function curve, however this may be difficult in practice.

LBO may also an advantage over KTP due to its capacity to optimally phasematch a large range of wavelengths with only a small change in the phase matching angle of LBO 10 and KTP 20 as shown in FIG. 1B. At 300K, the phase matching condition angular difference between 1061 and 1074 nm is 14.8° and 0.8° for KTP and LBO respectively. As a result, the net conversion of parasitic wavelengths in LBO may be higher than for KTP for uncollimated input beams that span a range of angle (eg. for focussed beams), at least for the parasitic rays having a wavelength close to the optimal phasematching angle. The acceptance angle for efficient harmonic generation is typically <1 deg and it is the acceptance angle (which is wavelength dependent) that determines the efficiency with which multiple transitions may be simultaneously converted by the nonlinear material. Consequently, LBO may also allow for more effective partial phase matching of 1061, 1064 and 1074 nm simultaneously, which avoids damage and increases the second harmonic efficiency. Similarly, when operating at 1319/1338 nm (these two transitions both operate simultaneously usually, as they are reasonably equal in strength, even though this is not apparent from the Table 1), the type I angular phase matching angles at 300K are (theta=85.9, phi=0) for 1319 nm and (theta=86.0, phi=0) for 1338 nm, which are also sufficiently close that the phase-matching condition is satisfied simultaneously.

The length of the LBO crystal is determined by the need to achieve efficient conversion whilst providing sufficient nonlinear loss at the wavelengths of the parasitic transitions to prevent damage to the components of the laser system. If the nonlinear crystal is too short, the conversion efficiency of the main fundamental wavelength (i.e. the wavelength of primary interest and for which the nonlinear material is configured for optimal phase matching) may become low. Moreover, when attempting generate high output energies the intracavity field may build up to a level that will induce damage. If the crystal is too long, damage may also occur; the angular and wavelength acceptance values scale inversely with crystal length and as a result the conversion efficiency of the fundamental and parasitic wavelengths will decrease. In the arrangements of the laser system, the length of the nonlinear LBO crystal for optimal (efficient) operation whilst balancing the above effects may be in the range of approximately 10 to 15 mm, or in the range of approximately 5 to 20, 5 to 15, 5 to 10, 10 to 20 or 15 to 20 mm and may be approximately 5, 6, 7, 8, 9, 10, 11, 12, 13, 14, 15, 16, 17, 18, 19 or 20 mm.

### Type I vs Type II Conversion

Green Generation Phase Matching (1064 nm, 1061 nm, and 1074 nm)

The angular difference between SHG phase matching for 1064 and 1061 nm in LBO is 0.2 and 0.4 degrees for type I and type II interactions respectively. The angular difference between SHG phase matching for 1064 and 1061 nm in KTP is 2.8 degrees for the type II interaction (type I interaction is not possible).

### Red Generation Phase Matching (1319 and 1338 nm)

The wavelength acceptance of LBO is greater than 25 nm for wavelengths near 1330 nm for both Type I and II phase matching. In terms of angle, the difference between SHG phase matching angle for 1319 nm and 1338 nm in LBO is 0.1 and 0.4 degrees for type I and type II interactions respectively i.e. at 1330 nm, the Type I acceptance angle of LBO is 300 mrad.cm, and the acceptance bandwidth is approximately 800 cm⁻¹ .cm. For o+e=e interactions (Type II) in LBO, the acceptance angle and the acceptance bandwidth are respectively 24 mrad.cm, and approximately 70 cm⁻¹ .cm. For e+e=o interactions (Type I) in LBO, the acceptance angle and the acceptance bandwidth are respectively 23 mrad.cm, and approximately 800 cm⁻¹.cm.

The sum frequency condition lies in between the two second harmonic conditions. For KTP, several different cuts provide type II interactions for 1319 and 1338 nm, but even these pairs are both 0.8 degrees apart, which is a greater difference than for LBO.

### Discussion

It is easy to see that for the case of LBO, the angular difference between the two phase matching conditions is quite small, and is in fact smaller than the incoming cone of focussed radiation in the resonator. The differential between the two phase matching conditions is even smaller given that there is a slight temperature gradient along the crystal. The KTP phase matching on the other hand is not greatly affected by temperature and the angular difference between the two phase matching conditions is far too great to convert both wavelengths simultaneously.

In an arrangement of the laser system, a plurality of laser beams having different wavelengths are generated in a laser cavity, with each of the laser beams resonating within the cavity simultaneously. The cavity may be a high-Q cavity for all of the different laser wavelengths resonating therein. This may be accomplished by suitable choice of mirrors, or reflectors, and coatings thereon in order to achieve high reflectivity for the wavelengths in the cavity. Indeed, this is normally the case as it is often difficult to manufacture mirrors that are highly reflective at the fundamental wavelength only, when the laser lines are within a few tens of nanometers of each other. By passing these frequencies to a nonlinear material such as a frequency doubler or a sum frequency generator that is capable of being tuned to convert the wavelengths of the laser light resonating in the cavity, output laser light may be generated. An output reflector capable of transmitting laser light within the range of output wavelengths which may be selected, but reflective to the unconverted wavelengths, allows output of a selected visible wavelength of laser light, while allowing the unconverted wavelengths to continue to resonate within the cavity. The output reflector may be an output coupler, for decoupling and outputting an output beam from the cavity. The output reflector may be highly reflective for those wavelengths that resonate within the cavity and are not outputted therefrom (commonly the fundamental wavelengths) and may be at least partially transmissive, possibly highly transmissive, for all wavelengths that may be outputted from the cavity i.e. wavelengths that have been shifted by the nonlinear material.

The laser medium may be capable of emitting, in use, cavity laser radiation, when pumped by a pump source. The pump radiation may be generated by supplying current to a diode pump laser, such that a portion of the power of the pump radiation is absorbed by the laser medium. The pump radiation may be radiation from a diode laser, a fibre coupled diode laser or it may be light from an arclamp or flashlamp or from some other pump source. The pumping may be end pumping or side pumping. The power of the pump radiation may depend on whether the laser is end pumped or side pumped, on the nature of the laser medium and on other factors. For diode pumping, the power of the pump radiation may be between about 0.1 and about 100 W, or between about 0.5 and 100, 1 and 100, 10 and 100, 50 and 100, 0.1 and 50, 0.1 and 10, 0.1 and 5, 0.5 and 5, 0.5 and 2, 0.8 and 1.5, 10 and 90, 10 and 70, 10 and 60, 10 and 50, 10 and 30, 15 and 25 or 20 and 25, and may be about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 16, 176, 18, 19, 20, 21, 22, 23, 24, 25, 26, 27, 28, 29, 30, 35, 40, 45, 50, 60, 70, 80, 90 or 100 W, or more than 100 W.

In the case of flashlamp pumping, the laser may be side pumped. Flashlamps are capable of generating high intensity pump radiation, and therefore enable high output energies from the laser. A flashlamp pumped system may be constructed with or without a Q-switch. It may have an average output power of up to about 50 W, or up to about 40, 30, 20 or 10 W, or of over about 0.5, 1, 2, 3, 4, 5, 6, 7, 8, 9, 10, 15, 20, 25 or 30 W, and may have an output power of about 0 to about 10 W, about 10 to 20 W, about 20 to 30 W, about 30 to 40 W, about 40 to 50 W, about 10 to 50 W, about 10 to 30 W, about 20 to 30 W, about 20 to 50 W or about 20 to 40 W, and may have an output power of about 1, 2, 3, 4, 5, 6, 7, 8, 9, 10, 15, 20, 21, 22, 23, 24, 25, 26, 27, 28, 29, 30, 35, 40, 45 or 50 W or more than about SOW. It may have an output energy of between about 5 and about 20 J in the visible range, or between about 5 and 15, 5 and 10, 10 and 20, 15 and 20, 10 and 15, 6 and 14, 7 and 13, 7 and 12, 7 and 11, 8 and 11 or 8 and 10 J, and may have an output energy of about 5, 6, 7, 8, 9, 10, 11, 12, 13, 14, or 15 J or more than about 15 J in the visible range. The flashlamp, and the corresponding output from the laser system, may have a pulse frequency of between about 0.1 and about 20 pulses per second (i.e. Hz), and may have a pulse frequency of between about 0.1 and 10, 0.1 and 5, 0.1 and 2, 0.1 and 1, 0.1 and 0.5, 1 and 20, 5 and 20, 10 and 20, 1 and 10, 1 and 5 or 5 and 10 pulses per second, for example about 0.5, 1, 1.5, 2, 2.5, 3, 3.5, 4, 4.5, 5, 6, 7, 8, 9, 10, 11, 12, 13, 14, 15, 16, 17, 18, 19 or 20 or more than 20 pulses per second. Alternatively the flashlamp, and the corresponding output from the laser may be a single shot system, or have a pulse frequency of less than about 0.1 Hz. The pulse duration may be between about 0.1 and about 50 ms, or may be between about 0.1 and 20, 0.1 and 10, 0.1 and 5, 0.1 and 2, 0.1 and 1, 0.1 and 0.5, 1 and 50, 5 and 50, 10 and 50, 20 and 50, 1 and 20, 1 and 10, 10 and 20, 20 and 30 or 5 and 20 ms, and may be about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 25, 30, 35, 40, 45 or 50 ms. Commonly only a proportion of the energy of a flashlamp is absorbed by the laser medium, for example less than about 25%, or less than about 20, 15 or 10%. Pumping may use energies of up to about 5 kJ per pulse. The energy may be between about 0.5 and about 5 kJ per pulse, or between about 1 and 5, 2 and 5, 3 and 5, 0.5 and 3, 1 and 4 or 2 and 3 kJ/pulse, and may be about 0.5, 1, 1.5, 2, 2.5, 3, 3.5, 4, 4.5 or 5 kj per pulse, or may be more than about 5 kJ/pulse. The power of the pulse may be between about 1 and about 20 kW or more than 20 kW. It may be between about 1 and 10, 1 and 5, 1 and 2, 5 and 20, 10 and 20, 2 and 15 or 5 and 10 kW, and may be about 1, 2, 3, 4, 5, 6, 7, 8, 9, 10, 11, 12, 13, 14, 15, 16, 17, 18, 19 or 20 kW.

Arrangements of the laser system may operate with a low pulse repetition rate and a high pulse energy, or it may operate with a high pulse repetition rate and a low pulse energy. It may operate with bursts, each of which comprises multiple pulses. The bursts may be repeated at a burst-repetition rate between about 0.1 Hz and about 20 Hz, or between about 0.5 and 20 Hz, 0.5 and 10, 0.5 and 5, 0.5 and 2, 1 and 20, 5 and 20, 10 and 20, 1 and 10 or 1 and 2 Hz, for example about 0.1, 0.5, 1, 1.5, 2, 2.5, 3, 3.5, 4, 4.5, 5, 6, 7, 8, 9, 10, 11, 12, 13, 14, 15, 16, 17, 18, 19 or 20 Hz. Each of said bursts may have a duration greater than about 2 milliseconds, or greater than about 3, 4, 5, 6, 7, 8, 9 or 10 milliseconds. The bursts may have a duration in the range of 1 to 200 ms, or alternatively, the burst duration may be in the range 1 to 150, 1 to 100, 1 to 50, 10 to 75, 10 to 150, or 50 to 100, and may be approximately 1, 2, 5, 10, 15, 20, 25, 30, 40, 50, 60, 70, 80, 90, 100, 110, 120, 130, 140, 150, 160, 170, 180, 190 or 200 ms. Each burst may comprise two or 35 more output pulses (e.g. 3, 4, 5, 6, 7, 8, 9, 10 or more than 10) having a duration of about 0.1 to about 1 millisecond, or about 0.25 to about 0.4 milliseconds. Each pulse in the burst of pulses may have a duration of between about 0.1 and 0.5, 0.1 and 0.2, 0.2 and 1, 0.5 and 1, 0.2 and 0.8, 0.2 and 0.6, 0.2 and 0.4 or 0.3 and 0.4, for example about 0.1, 0.2, 0.3, 0.4, 0.5, 0.6, 0.7, 0.8, 0.9 or 1 millisecond.

It will be understood by one skilled in the art that the frequency and wavelength of a laser beam are connected by the equation:

Speed of light=wavelength*frequency

As a consequence, when reference is made to frequency, frequency shifting, frequency converting, different frequencies, and similar terms, these are interchangeable with the corresponding terms wavelength, wavelength shifting, wavelength converting, different wavelengths, and the like.

In constructing an arrangement of the present laser system, it is crucial that components of the laser are correctly positioned in order to achieve acceptable conversion efficiency to output laser power. The laser system may be a solid state laser.

### Materials

The materials used for the laser medium and the non-linear material are well known in the art. Commonly neodymium is used as the dopant in the laser medium, and suitable laser mediums include, Nd:YLF, Nd:YAG, Nd:YALO (Nd:YAP), Nd:GdVO₄ and Nd:YVO₄, although other dopant metals may be used. Other dopant metals that may be used include ytterbium, erbium and thulium, and other host materials that may be used include YAB, YCOB, KGW and KYW.

Examples of materials used for frequency doubling or sum frequency generation include crystalline LBO, BBO, BiBO, KTP, CLBO, DLAP, ADP or periodically poled materials such as lithium niobate, KTP, KTA, RTA or other suitable materials. Periodically poled materials may generate frequency doubled or sum frequency outputs through quasi-phase matching. An advantage of LBO is that it may be easily configured for either temperature tuning or for angle tuning, and also provides efficient conversion to visible frequencies. It has been found that LBO is particularly favoured in the arrangements of the laser system. A way to configure a non-linear crystal relates to the way the crystal is “cut” relative to its “crystal axes”. These crystal axes are a fundamental property of the type of crystal. The crystal may be manufactured with a “cut” to approximately provide phase-matching between a selected wavelength and its second harmonic. Fine tuning of this phase-matching may be achieved by “angle-tuning” the medium. Alternatively the fine tuning may be achieved by temperature tuning the medium. The angle tolerance may be less than 0.1 degree, and temperature may be maintained within 0.1 degree. The tolerance may be up to about 10 degrees of angle or of temperature, or up to about 9, 8, 7, 6, 5, 4, 3, 2, 1, 0.5, 0.4, 0.3 or 0.2 degrees of angle or of temperature, and may be about 0.05, 0.1, 0.2, 0.3, 0.4, 0.5, 0.6, 0.7, 0.8, 0.9, 1, 2, 3, 4, 5, 6, 7, 8, 9 or 10 degrees of angle or of temperature. These tolerances vary depending on the nature of the crystal.

A non-linear crystal may be cut for Type I phase matching (o+o=e) or for Type II phase matching (o+e=e). In the case of Type I phase matching, as used in the present arrangements, the polarizations of the input frequencies are parallel to each other and to a defined plane of the crystal, and the polarization of the output is orthogonal to the input frequencies. In the case of Type II phase matching, the polarizations of the input frequencies are orthogonal to each other, and one of the input frequencies is parallel to a defined plane of the crystal. In this case the output is orthogonal to the defined plane and to the polarization of one of the input frequencies and parallel to the polarization of the other input frequency.

### Location of Elements

It is important for the efficient operation of the laser system described herein that the component parts of the system be located correctly. In particular, the nonlinear material should be located at a position in the cavity where the diameter of the beam to be wavelength converted is sufficiently small to achieve acceptable conversion efficiency.

Commonly, the refractive index of a laser medium changes with an increase in temperature, and consequently the laser medium acts as a lens. The laser system may be operated under conditions in which thermal lensing arises. Achievement of increased output power necessitates a consideration of the resonator spatial-mode dynamics which will depend on the thermal lensing. The thermal lens may impact on the stability characteristics of the laser system. The thermal lensing effect of the components of the laser system may change with a change in pump power. The laser may comprise a cooler for cooling the laser medium.

Due to thermal lensing within the different components of the laser system, in addition to curvature of the cavity mirrors and natural diffraction, the beam width of a laser beam within the resonator cavity of the laser system will vary along the length of the cavity. Since the efficiency of the processes occurring in the nonlinear material increases with an increase of the power of the incident laser beam, the location of the nonlinear material is critical to the efficient operation of the system. Furthermore, since the heating of components of the system is due to passage of a laser beam through those elements, the optimum location of the elements will vary with the power of the laser system.

Suitably a curvature of at least one of the reflectors and/or the position of the laser medium relative to the cavity configuration are such that the resonator is maintained within a stable and preferably efficient operating region (it is noted that neither the mirror curvature or the location of the mirror affects the focal length of the thermal lenses in either the laser material or the nonlinear material). This may be achieved by optimising the cavity configuration as a function of the focal lengths by in addition to positioning the laser medium within the cavity and/or selecting a curvature of at least one of the reflectors, optimising the transmission characteristics of the output coupler and/or the pulse repetition frequency.

The transmission characteristics of the output coupler may be such that the output coupling at the desired wavelength is between about 1 and about 100%, or between about 5% and 100%. The output coupling may be between about 1 and 80, 1 and 50, 1 and 30, 1 and 20, 1 and 10, 1 and 5, 5 and 90, 5 and 80, 5 and 70, 5 and 60, 5 and 50, 5 and 40, 5 and 30, 5 and 20, 10 and 100, 50 and 100, 70 and 100, 80 and 100, 80 and 90, 90 and 100, 90 and 95 or 10 and 50%, and may be about 1, 2, 3, 4, 5, 6, 7, 8, 9, 10, 15, 20, 25, 30, 35, 40, 45, 50, 55, 60, 65, 70, 75, 80, 85, 90, 95, 96, 97, 98, 99, 99.5 or 100%.

Thermal lensing may also be addressed by the inclusion of one or more additional components in the resonator cavity that themselves give rise to thermal lenses in such a manner as to at least partially counteract the thermal lenses of the other components. Thus for example if the nonlinear material provides a negative lens, an additional component may be located in the cavity that provides a positive lens of comparable magnitude to the negative lens. Alternatively, a means may be included to move the components of the laser system in order to compensate for the thermal lens. Thus one or more motors may be provided in order to move one or more components of the laser system to an optimum position. The motors may be controlled by a computer, which may be capable of receiving information from the cavity (e.g. temperature, intensity of laser light etc.), using the information for determining the optimum position of the components of the system, and providing one or more signals to the one or more motors in order to signal them to move the one or more components to the optimum position(s). The feedback system as described above may be continuous, in order to compensate for changes in the thermal lensing with temperature during operation of the laser system.

In some arrangements, the laser is also optimised for given pump powers for optimum mode sizes in the laser gain material and the nonlinear material and optimum laser output power so as to obtain efficient energy extraction from the laser medium as well as efficient wavelength conversion in the non-linear material whilst maintaining cavity stability and avoiding optical damage of the laser components i.e., the various components are matched on the basis of their associated mode sizes. The cavity is suitably optimised so that the relative mode size in each of the materials present in the cavity is such so as to provide efficient stable output. Suitably, overall conversion efficiencies from optical pump power to visible output power of up to about 5%, more commonly up to about 3%, are obtainable for flashlamp pumped lasers. The conversion efficiency in these systems may be up to about 4, 3, 2 or 1%, and may be between about 0.2 and about 5%, or between about 0.2 and 2, 0.2 and 1, 0.5 and 5, 0.5 and 3, 0.5 and 2, 0.5 and 1, 1 and 5, 0.2 and 3, 0.5 and 3or 1 and 3%, and may be about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5 or 5%. In diode pumped lasers, the conversion efficiency may be higher. In such systems it may be up to about 5, 10, 15, 20 or 25%, e.g. between about 1 and 25%, or between about 5 and 25, 10 and 25, 20 and 25, 5 and 20, 5 and 10 or 10 and 20%, e.g. about 5, 6, 7, 8, 9, 10, 15, 20 or 25%.

In order for the laser to operate with suitable optimal efficiency the key design parameters (ie mirror curvatures, cavity length, positioning of the various components) are suitably chosen so that the resonator mode sizes in the laser medium (denoted by subscript A) and the nonlinear material (e.g. frequency-doubling crystal) (denoted by subscript C) are near-optimum at a desired operating point. One can denote the beam sizes (radii) in these media as ω_{A} and ω_{C} respectively. In cases where the laser beam is not circular, it is commonly elliptical, and the beam size may be considered along the long and short axes of the ellipse. The beam size is taken to be the distance from the beam axis to the point where the intensity of the beam falls to 1/(e²) of the intensity of the beam axis. The beam size may vary along the length of a particular component. The beam size in a particular component may be taken as the average beam size within the component or as the minimum beam size within that component. ω_{A} is suitably mode-matched to the dimension of the pumped region of the laser medium i.e., the pump spot size (ω_{P}). This is particularly relevant to diode pumped systems, in which a discrete pump beam is generated. ω_{P} can vary according to the power of the pump laser source (e.g., a diode laser) and the pumping configuration. For example a laser crystal end-pumped with a low power (˜1 W) diode laser may have a ω_{P} of approximately 100 μm, for example between about 50 and about 200 μm, or between about 50 and 150, 50 and 120, 50 and 100, 50 and 70, 70 and 200, 100 and 200, 120 and 200, 150 and 200, 70 and 150, 80 and 130 or 90 and 110 μm, and may have a ω_{P} of approximately 50, 60, 70, 80, 90, 100, 110, 120, 130, 140, 150, 160, 170, 180, 190 or 200 μm. A laser crystal end-pumped with a 10-60 W diode laser may have a ω_{P} in the range 90 to about 700 μm, for example approximately 100 to 700, 100 to 500, 100 to 300, 150 to 650, 150 to 250, 200 to 600, 300 to 400, 250 to 350, 200 to 375, 90 to 400, 200 to 700, 400 to 700, 500 to 700, 200 to 400 or 400 to 600 μm, and may have a ω_{P} about 90, 100, 150, 200, 250, 300, 350, 400, 450, 500, 550, 600, 650 or 700 μm. A laser crystal side-pumped by one or more diode lasers may have a ω_{P} in the range of about 500 to about 1500 μm, for example between about 500 and 1200, 500 and 1000, 500 and 700, 700 and 1500, 1000 and 1500, 1200 and 1500, 600 and 1400, 700 and 1300, 800 and 1200 or 900 and 1100 μm, and may have a ω_{P} about 500, 550, 600, 650, 700, 750, 800, 850, 900, 950, 1000, 1050, 1100, 1150, 1200, 1250, 1300, 1350, 1400, 1450 or 1500 μm. When flashlamp pumping is used, larger pump mode sizes may be used. In this case ω_{P} may be up to about 10 mm in the laser crystal, or up to about 9, 8, 7, 6, 5, 4, 3, 2 or 1 mm, or between about 0.5 to about 10 mm, or about 1 to 10, 2 to 10, 3 to 10, 4 to 10, 5 to 10, 0.5 to 10, 0.5 to 5, 0.5 to 2, 0.5 to 1, 1 to 5, 5 to 10 or 3 to 5 mm, and may be about 0.5, 1, 1.5, 2, 2.5, 3, 3.5, 4, 4.5, 5, 5.5, 6, 6.5, 7, 7.5, 8, 8.5, 9, 9.5 or 10 mm, or may be greater than about 10 mm.

Flashlamp pumping provides a pump mode size which is the diameter of the laser medium (or rod). This may be up to about 10 mm for YAG. For other materials it may be still larger, and may be up to about 20 mm, and may thus also be about 19, 18, 17, 16, 15, 14, 13, 12 or 11 mm. Flashlamp pumping may provide no control over the pump mode size.

Optimal mode-matching of ω_{P} and ω_{A} is a suitable pre-requisite for enabling efficient extraction of the gain in the laser medium, particularly in the case of diode-pumped lasers. When ω_{P} and ω_{A} are mode matched, the pump laser radiation overlaps with the cavity laser beam within the laser medium. If ω_{A} is too small, then (i) laser gain may not be extracted efficiently into the TEM₀₀ resonator mode and (ii) the laser may oscillate on higher-order modes which are generally not desirable. If ω_{A} is too large, then diffraction losses can occur in the resonator due to aberrations in the thermal lens associated with the laser crystal. This effect is undesirable and deleterious for pumping powers approximately ≧3 W.

$$\frac{{ω}_{A}}{{ω}_{P}}$$

may be in the range about 0.45 to about 1.55, 0.45 to 1.5, 0.45, to 1.3, 0.45 to 1, 0.45 to 0.8, 0.45 to 0.55, 0.5 to 1.55, 0.8 to 1.55, 1 to 1.55, 1.2 to 1.55, 0.5 to 1.5, 0.6 to 1.4, 0.7 to 1.3, or 0.75 to 1.25 or 0.7 to 1.25 or 0.75 to 1.3 or 0.8 to 1.2 or 0.9 to 1.1 or 0.95 to 1.05.

$$\frac{{ω}_{A}}{{ω}_{P}}$$

may be about 1.01, 1.02, 1.03, 1.04, 1.05, 1.06, 1.07, 1.08, 1.09, 1.1, 1.12, 1.14, 1.16, 1.18, 1.2, 1.25, 1.3, 1.35, 1.4, 1.45, 1.5, 1.55, 0.99, 0.98, 0.97, 0.96, 0.95, 0.94, 0.93, 0.92, 0.91, 0.9, 0.88, 0.86, 0.84, 0.82, 0.8, 0.75, 0.7, 0.65, 0.6, 0.55, 0.5 or 0.45, or may be equal to or about 1. ω_{A} may be greater than or equal to ω_{P}. The pump spot size may overlap completely with the cavity laser beam within the laser medium. When the pump spot size is mode matched to the mode of the cavity laser beam in the laser medium in the resonator, the excitation of the fundamental Gaussian mode (TEM₀₀) may be the main mode in the resonator cavity, or there may be higher-order transverse modes present. ω_{A} may be in the range of about 70 to 850 μm, for example about 100 to 850, 250 to 850, 400 to 850, 550 to 850, 70 to 500, 70 to 300, 70 to 150, 100 to 600, 200 to 500, 100 to 300, 300 to 500, 500 to 700 or 700 to 850 μm, and may be for example about 70, 100, 150, 200, 250, 300, 350, 400, 450, 500, 550, 600, 650, 700, 750, 800 or 850 μm. ω_{C} is suitably optimised for efficient frequency conversion through the frequency doubling process. The optimum value for ω_{C} varies according to the type of crystal used. Different crystals have different non-linear coefficients, walk-off angles and damage thresholds. If ω_{C} is too large, then conversion efficiency will be lower than optimum. If ω_{C} is too small then (i) optical damage can occur to the crystal, and (ii) the effective length of the non-linear interaction can become too short due to “walk-off” effects. Typical values for ω_{C} are in the range about 90-600 μm, and may be in the range of about 100 to 600, 200 to 600, 300 to 400, 250 to 350, 200 to 375, 90 to 400, 100 to 300, 400 to 600, 200 to 400 or 400 to 600 μm, and may be about 90, 100, 150, 200, 250, 300, 350, 400, 450, 500, 550 or 600 μm. This discussion assumes that the mode size in A and C is the same for optical fields at different wavelengths. In practice ω_{A} and ω_{C} may be slightly different (by <10%) owing to effects such as gain-guiding and self-focussing.

Suitably the mode size (beam size) in the laser medium is approximately equal to the pump spot size. A preferred situation is when ω_{A}>ω_{C}.

In some arrangements, the thermal lens focal lengths for the laser medium at the laser input powers is determined and the position of the laser medium in the cavity is selected to ensure that during operation of the laser the resonator is stable. Suitably the thermal lenses for the laser medium can be calculated and then confirmed by cavity stability measurement. Alternatively the thermal lenses can be determined by standard measurement techniques such as lateral shearing interferometry measurements which can also provide information on any aberrations. A suitable interferometric technique is described in M. Revermann, H. M. Pask, J. L. Blows, T. Omatsu “Thermal lensing measurements in an intracavity LiIO₃ Laser”, ASSL Conference Proceedings February 2000; in J. L. Blows, J. M. Dawes and T. Omatsu, “Thermal lensing measurement in line-focus end-pumped neodymium yttrium aluminium garnet using holographic lateral shearing interferometry”, J Applied Physics, Vol. 83, No. 6, March 1998; and in H. M Pask, J. L. Blows, J. A. Piper, M. Revermann, T. Omatsu, “Thermal lensing in a barium nitrate Raman laser”, ASSL Conference Proceedings February 2001.

The desired operating power may be such that the output power is greater than about 1 W. Arrangements of the laser system may have an average output power of up to about 50 W, or up to about 40, 30, 20 or 10 W, and may have an output power of about 0 to about 10 W, about 10 to 20 W, about 20 to 30 W, about 30 to 40 W, about 40 to 50 W, about 10 to 50 W, about 10 to 30 W, about 20 to 30 W, about 20 to 50 W or about 20 to 40 W, and may have an output power of about 1, 2, 3, 4, 5, 6, 7, 8, 9, 10, 15, 20, 21, 22, 23, 24, 25, 26, 27, 28, 29, 30, 35, 40, 45 or 50 W or more than about 50 W. Alternatively, it may be between about 10 mW and about 1 W, or between about 100 mW and 1 W, 500 mW and 1 W, 100 and 500 mW, 50 and 500 mW or 10 and 100 mW, and may be about 10, 20, 30, 40, 50, 60, 70, 80, 90, 100, 150, 200, 250, 300, 350, 400, 450, 500, 550, 600, 650, 700, 750, 800, 850, 900, 950 or 1000 mW.

A suitable stability plot for a two-mirror resonator can be determined as follows. The ray transfer matrix (M) is calculated for a transit of the optical resonator. The elements of this matrix

$$M = [ \begin{matrix}A & B \\ C & D\end{matrix} ]$$

enable an equivalent (two-mirror) resonator to be defined with equivalent g-parameters g₁^{*}=A, g₂^{*}=D and L*=B. The optical system in the resonator cavity may be described by an ABCD matrix which is the product of one or more ABCD matrices, each of which corresponds to an optical element through which light passes. The ABCD law enables one to calculate the change in a Gaussian laser beam as the beam passes through a particular element. The determinant of the matrix M should be unity for a stable arrangement of the resonator cavity, i.e. AD−BC=1. The stability regime for the resonator cavity is where the cavity laser beam obeys the inequality |S|≦1, where S=0.5*(A−D). The predominant mode of the cavity laser beam may be a Gaussian beam. A Gaussian beam is one in which the cross-sectional power profile of the beam has a Gaussian distribution. The q parameter of a Gaussian laser beam at a particular position in a resonator needs to satisfy the ABCD law: q=(Aq+B)/(Cq+D). The solutions to this are given by:

$$\frac{1}{q \pm } = \frac{D - A}{2 B} ∓ \frac{1}{B} \sqrt{( {( \frac{A + D}{2} )}^{2} - 1 )}$$

The allowed solution should have a negative imaginary component. The q parameter incorporates the mode size and the beam curvature, and is described in detail in the B. E. A. Saleh and M. C. Teich, Fundamentals of Photonics, John Wiley and Sons, New York, 1991, the contents of which are incorporated herein by cross-reference. The mode size of the cavity laser beam may be determined along the resonator cavity from the q parameter.

In particular, for a system having a lens of focal length f (i.e. refractive power 1/f) located a distance d₁ from a first mirror having radius of curvature R₁, and a distance d₂ from a second mirror having radius of curvature R₂, the elements of the matrix M are:

A=g1*

B=L*

C=(g1**g2*−1)/L*,

D=g2*

where L*=d1+d2-D*d1*d2 and where gᵢ*=g₁−D*dⱼ(1−dᵢ/Rᵢ); i, j=1, 2; i≠j

Texts describing this method are N. Hodgson and A. Weber, “Optical Resonators”, Springer-Verlag London Limited, 1997 and W. Koechner, “Solid-state Laser Engineering”, Springer-Verlag, 1992.

The dynamic nature of the laser resonator as the diode current is increased can be simulated by calculating g₁^{*} and g₂^{*} for suitable combinations of the thermal lenses in the components of the lasers. When plotted on a stability plot, a curve can be defined. In a well-designed resonator, this curve will lie in a stable region of the stability plot (ie in the region where 0≦g₁^{*}*g₂^{*}≦1) from the point where laser action is initiated to the point corresponding to the desired operating power.

In the present context, mode matching is the process of matching the pump laser beam waist in the laser medium with the beam waist of the cavity laser beam in the laser medium. In order to perform mode matching of the pump laser beam with the cavity laser beam, the ABCD law may be used to determine the mode size of the cavity laser beam in the laser medium and the pump laser beam may be focussed onto or into the laser medium such that the mode size of the pump laser beam matches or about matches the mode size of the cavity laser beam. An example of mode matching the pump laser beam with the cavity laser beam is provided in PCT/AU01/00906, the contents of which are incorporated herein by cross-reference. Mode matching may be required in order to achieve optimal power from the laser system.

The laser medium can be pumped/stimulated by a pulsed or continuous arclamp, flashlamp or diode (semiconductor) laser using a side-pumped, single end-pumped or double end-pumped geometry. End pumping of the laser crystal is a very efficient approach to generating laser output. Compared to side-pumped laser crystals, end-pumped laser crystals generally have high gain and give rise to short Q-switched pulses, and the pump spot size in the laser crystal can be adjusted to match the resonator mode size. However end-pumped laser crystals can also give rise to strong (and abberated) thermal lensing, and this ultimately limits the scalability of end-pumped lasers.

Side-pumping of the laser crystal may not result in such high optical-optical conversion efficiency, but it is a cheaper approach, is more easily scalable and enables greater flexibility in where the resonator components can be placed.

The laser beam may be Q-switched in order to obtain sufficiently high peak powers for efficient frequency conversion. The power of the laser beam at each element of the laser system should however be below the damage threshold of that element. Thus the energy of the laser beam in the laser medium should be below the damage threshold for that particular laser medium and the energy of the laser beam in the nonlinear material should be below the damage threshold for that particular nonlinear material. The damage threshold of a particular element will depend, inter alia, on the nature of that element. The peak power of a laser pulse generated by a Q-switch may be calculated by dividing the energy by the pulse width. Thus for example if the laser pulse energy is 200 μJ and the pulse width of the Q-switched laser beam is 10 ns, then the laser power will be 200 μJ/10 ns, ie 20 kW. The power density of the laser beam at any particular location may be calculated by dividing the power of the laser beam at that location by the mode size (area) at that location. The power density of the laser beam at each element of the system maybe below the damage threshold for that particular element, that is the power densities for the laser medium and the nonlinear material, should be below their respective damage thresholds. Since the repetition rate of the Q-switch affects the power deposition in the elements of the laser system, it will affect the heating and hence the thermal lensing of those elements. Most importantly, and usefully in the design of the laser system, the choice of repetition rate affects the peak power of the cavity laser beam.

The repetition rate should therefore be chosen such that the system is stable and so that the damage thresholds of the elements are not exceeded. The repetition rate may be between about 1 Hz and about 50 kHz, and may be between about 1 Hz and 10 kHz or about 1 Hz and 10 Hz or about 1 and 100 Hz, about 1 and 10 Hz or about 1 and 5 Hz or about 5 and 200 Hz, 10 and 200 Hz, 50 and 200 Hz, 100 and 200 Hz, 5 and 100 Hz, 5 and 50 Hz, 5 and 20 Hz, 5 and 10 Hz, 10 and 100 Hz, 50 and 100 Hz or about 100 Hz and 50 kHz or about 1 and 50 kHz or about 10 and 50 kHz or about 20 and 50 kHz or about 1 and 15 kHz or about 15 and 50 kHz or about 10 and 30 kHz or about 5 and 10 kHz or about 5 and 15 kHz or about 5 and 20 kHz or about 5 and 25 kHz or about 7.5 and 10 kHz or about 7.5 and 15 kHz or about 7.5 and 20 kHz or about 7.5 and 25 kHz or about 7.5 and 30 kHz or about 10 and 15 kHz or about 10 and 20 kHz or about 10 and 25 kHz, and may be about 1, 1.5, 2, 2.5, 3, 3.5, 4, 4.5, 5, 6, 7, 8, 9, 10, 15, 20, 25, 30, 35, 40, 45, 50, 60, 70, 80, 90, 100, 200, 300, 400, 500, 600, 700, 800 or 900 Hz or about 1, 2, 3, 4, 5, 6, 7, 8, 9, 10, 15, 20, 25, 30, 35, 40, 45 or 50 kHz. The pulse duration of the Q-switched laser beam may be in the range of about 1 to about 100 ns, or about 1 to 50 ns, or about 1 to 20 ns or about 1 to 10 ns or about 5 to 80 ns or about 5 to 75 ns or about 10 to 50 ns or about 10 to 75 ns or about 20 to 75 ns or about 5 to 100 ns or about 10 to 100 ns or about 20 to 100 ns or about 50 to 100 ns or about 5 to 50 ns or about 10 to 50 ns, and may be about 1, 2, 3, 4, 5, 6, 7, 8, 9, 10, 15, 20, 25, 30, 35, 40, 45, 50, 55, 60, 65, 70, 75, 80, 85, 90, 95 or 100 ns.

In general, the arrangements of the laser system may have a pulse duration that may range from picoseconds, for modelocked systems, to nanoseconds, for example for Q-switched systems, to microseconds for example for pulse pumped systems. The system may in some circumstances be continuous wave (CW) systems. Thus the pulse duration (for pulsed systems) may therefore range between about 1 ps to about 1 ms and may be between about 1 ps and 1, 1 ps and 1 ns, 1ns and 1 ms, 1 μs and 1 ms or 1 ns and 1 μs, and may be for example about 1, 5, 10, 50, 100 or 500 ps, about 1, 5, 10, 50, 100 or 500 ns, about 1, 5, 10, 50, 100 or 500 ns or about 1 ms. The resonator cavity may have a folded, bent or linear configuration or other suitable configuration. It may comprise a coupled cavity resonator.

A laser medium suitably generates laser beams at one or more fundamental wavelengths (see Table 1 for Nd:YAG) when stimulated by pump light of an appropriate wavelength, and the fundamental laser beam then propagates inside the laser resonator. Suitably the laser medium is formed by one of the following crystals: Nd:YAG, Nd:YLF, Nd:glass, Ti-sapphire, Erbium:glass, Ruby, Erbium:YAG, Erbium:YAB, Nd:YAlO₃, Yb:YAlO₃, Nd:SFAP, Yb:YAG, Yb:YAB, Cobalt:MgF₂, Yb:YVO₄, Nd:YAB, Nd:YVO₄, Nd:YALO, Yb:YLF, Nd:YCOB, Nd:GdCOB, Yb:YCOB, Yb:GdCOB or other suitable laser medium. The laser medium may be broadband AR-coated for the 1-1.2 micron region to minimise resonator losses. Optionally the laser medium is wavelength tunable and capable of generating high power output which can be mode-locked.

A solid nonlinear material is used for frequency doubling the laser beam resonating in the cavity, or for sum frequency generation to produce an output at its second harmonic or other sum frequency or different frequency wavelength. The solid nonlinear material is located in the cavity (intra cavity doubled—doubling crystal located inside the resonator). Suitable solid nonlinear materials include a second harmonic generator (SHG), a sum frequency generator (SFG) or a difference frequency generator (DFG). As examples of nonlinear material mention can be made of LBO, BBO, LiIO₃, KDP, KD*P, KBO, KTA, ADP, LN (lithium niobate) or periodically-poled LN or combinations thereof (e.g. to generate green and yellow lasers simultaneously). Suitably a LBO or BBO crystal is used. The light can be frequency doubled, frequency tripled (via third harmonic generation or THG) or frequency summed by angle-tuning and/or controlling the temperature (i.e. temperature tuning) of the solid nonlinear material. Typical variations in the visible wavelength with a LBO crystal cut for type 1 non-critical phase-matching with temperature tuning. By such frequency doubling it may be possible to generate wavelengths in the yellow or orange spectral region suitable for dermatological, ophthalmic and visual display applications, and by means of other processes such as sum frequency generation still further wavelengths may be generated. The resonator design may be such that the beam size in the doubling medium is sufficiently small to allow efficient conversion and high output powers but large enough to avoid optical damage. Suitably the nonlinear material is AR-coated to minimise losses in the 1-1.2 micron region and in the visible where possible. A suitable AR coated LBO crystal for intracavity use is 4×4×10 mm and for extracavity use is 4×4×10 mm although other sizes can be used.

### Non-Critical Phase Matching (NCPM) in LBO

Noncritical phase matching (sometimes called 90° phase matching) does not require a critical angular adjustment. The fundamental beam(s) is aligned so that it propagates along a desired axis of the birefringent crystal. Phase matching is achieved by adjusting the crystal temperature. FIG. 2 shows the phase matching temperature for a crystal cut at (theta=90°, phi=0°). Increasing the phi angle slightly effectively shifts these curves downwards. This provides an explanation for the fact that the crystal cut at (theta=90°, phi=11.3°) critically phase-matches for 1064+1064 nm at close to room temperature. It may be observed that phase-matching around room temperature is desirable, as low temperatures may create condensation problems and high temperatures may damage crystal coatings. Temperatures far from ambient may also be more difficult to achieve and maintain.

### Critical Phase Matching (CPM) in LBO

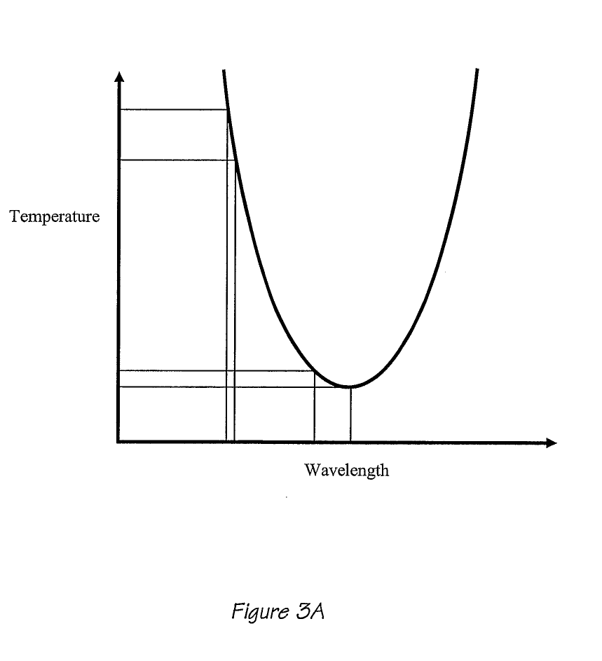

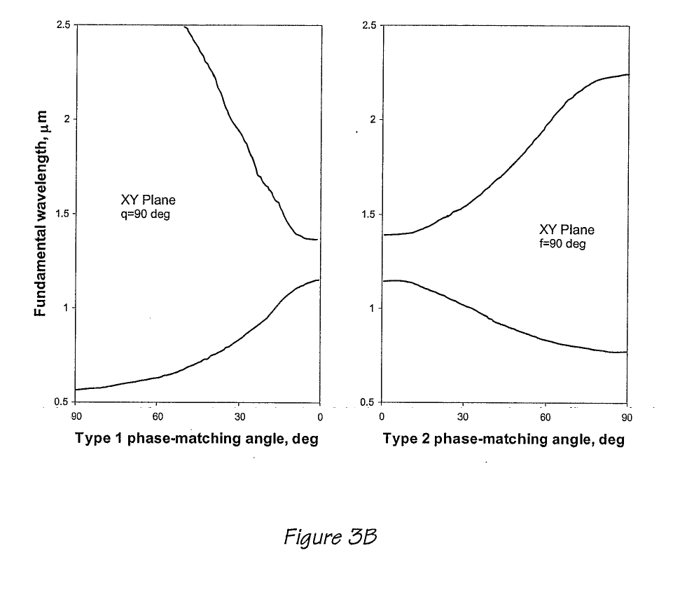

Critical phase matching occurs when the fundamental beam propagation is not aligned along a crystal axis (so the crystal cut is no longer at 0° or 90°) and crystal angle is changed to achieve phase-matching. The example shown in FIG. 3B is for temperatures around room temp. Notation expresses theta=q and phi=f.

FIG. 3A illustrates the variation in phase matching temperature with wavelength for type I SHG phase matching in LBO. FIG. 3A shows that two wavelengths that are relatively close may nevertheless phase match at temperatures that are relatively far apart, whereas two different wavelengths which are relatively far apart may phase match at very similar temperatures. Thus for example if the wavelengths marked are in order 1061, 1064, 1320 and 1340 nm (in which the graph is not to scale), it can be seen that the phase matching temperature difference between 1061 and 1064 nm is greater than between 1320 and 1340 nm, despite the fact that the wavelength difference between 1061 and 1064 nm (3 nm) is far smaller than between 1320 and 1340 nm (20 nm). The plurality of fundamental wavelengths converted by the nonlinear material may be sufficiently close in wavelength that the optimum temperature, or optimum angle, of the non-linear material for phase matching any one of the fundamental wavelengths with its corresponding converted wavelength is close to the optimum temperature or angle for phase matching any other of the fundamental wavelengths with its corresponding converted wavelength. The closeness may depend on various specific material characteristics or cavity parameters, and may for example, depending on said parameters, be less than about 5, 4.5, 4, 3.5, 3, 2.5, 2, 1.5, 1, 0.9, 0.8, 0.7, 0.6, 0.5, 0.4, 0.3, 0.2 or 0.1° (either of angle or of temperature). It may be in range of 5 to 0.1 or in the rang of 4 to 0.2°.

Preferably the resonator cavity is defined by at least two reflectors which can be two mirrors at least one of which is preferably curved to provide a stable output laser beam (the other mirror may be flat). Other suitable reflectors that can be used in the arrangements of the laser system include prisms or gratings. More preferably at least two curved mirrors are used. The mirrors may also be coated to have high transmission at the output wavelengths of interest. Reflectors can be provided with special dielectric coating for any desired wavelength. The mirrors can provide for the laser output to be coupled out of the cavity such as by use of a broadband dichroic mirror transmissive at the frequency of the output beam but suitably highly reflective at other frequencies so as to cause build-up of the power intensities of the beams in the cavity. Alternatively a polarisation beam splitter can be used to output the laser output. The radius of curvature and separation between the reflectors (cavity length) and transmission characteristics of the outcoupling mirror are suitably chosen to provide cavity stability for a sufficiently wide range of combinations of f_{L}. The radius of curvature of the reflectors are appropriately selected on the basis of the laser crystal used. Suitably the mirrors are chosen so as to be greater than 99% reflective at the laser wavelengths. The laser resonator cavity is suitably a stable resonator which supports the TEM₀₀ mode. For the intracavity-doubled laser, all mirrors/reflectors are suitably chosen to be >99% reflective at the fundamental wavelength. The frequency-doubled laser beam is suitably coupled out of the resonator through a dichroic mirror—i.e., a mirror which has high transmission at the frequency-doubled wavelength but high reflectivity at the fundamental wavelengths. The reflectors and/or mirrors may, independently, be flat or may be non-flat. They may have a radius of curvature between about 5 and about 100 cm or more, depending on factors described above. The radius of curvature of each mirror and/or reflector may be between about 10 and 100, 20 and 100, 50 and 100, 5 and 50, 5 and 20, 5 and 10, 10 and 50, 10 and 30, 15 and 25 or 18 and 22 cm, and may be about 5, 10, 15, 16, 17, 18, 19, 20, 21, 22, 23, 24, 25, 30, 35, 40, 45, 50, 60, 70, 80, 90, 100 cm, 150, 200, 300, 400 cm or 500 cm or may be some other value.

Suitably the transmission characteristics, radius of curvatures and separation of the reflectors are tailored to achieve efficient and stable operation of the laser and to generate output at the visible wavelengths by frequency doubling or sum frequency generation in the nonlinear material. Suitably the curvature of the reflectors and cavity length are optimised to obtain the desired mode diameter such that near-optimum beam sizes are achieved simultaneously in the laser medium and the nonlinear material such that changes in the focal lengths of the laser medium as a result of thermal effects in the laser medium during operation of the laser do not cause the laser modes to expand to the extent that the light suffers large losses. The laser medium and the nonlinear material can be positioned in the cavity as discrete elements or components. Alternatively one or more of the components can be non-discrete, one component performing the dual function of both the laser medium and the nonlinear material (such as self-frequency doubling or self doubling materials such as Yb:YAB and Nd:YCOB). Devices using such materials may provide low average power output. They may have the advantage of being extremely compact.

The pulse repetition frequency of the output can be varied by using a Q-switch such as an active Q-switch or a passive Q-switch. An acousto-optic Q-switch, an electro-optic Q-switch or passive Q-switches (Cr:YAG) can be used. Alternatively a cavity dumping configuration or other suitable means can be adopted (see “The Laser Guidebook” by Jeff Hecht, 2^{nd} Edition, McGraw-Hill 1992, the whole content of which is incorporated by cross reference). The Q-switch may be broadband AR-coated to minimise resonator losses. The selection and alignment of the Q-switch is tailored to achieve a high-Q resonator for the fundamental.

At least one polariser may be included in the cavity and may be one or two plates of glass at Brewsters angle and/or a polarizing cube, prism or other polariser. Such polarisers cause the fundamental to lase on only one linear polarisation. This is important for the type 1 phase matching of the laser.

### Reflectors

The transmission properties of the dielectric coatings on the cavity reflectors may be optimized to suit the output wavelength(s) of the laser system. Thus for example one reflector of the cavity may be optimised to transmit the pump beam frequency and reflect other frequencies that resonate in the cavity. Another reflector, the output reflector, may be optimised to be transmissive at the frequencies that may be outputted from the cavity and reflective at other frequencies that may resonate in the cavity. Alternatively the output laser beam may be coupled out of the cavity using a polarization selector. For example, since a Type I phase matched crystal is used, the input frequencies are polarized parallel to each other and the output frequency is polarized orthogonally to the input frequencies. A polarization selector may thus be used to couple only the orthogonal output frequency out of the cavity, while reflecting the input frequencies to resonate in the cavity.

### Quasi-Phasematching

There is a class of SHG/SFG materials, such as periodically-poled lithium niobate (PPLN), that use quasi-phasematching rather than the birefringence properties of the medium to achieve efficient conversion. Quasi-phasematching relies on the use of a periodic structure which forms a grating within the crystal, with alternating crystal domain direction (and hence sign of the nonlinear coefficient) so that the phase mismatch introduced in each domain is compensated in the next domain. As well as angle and temperature tuning, quasi-phasematched materials may also be tuned by altering the period of the grating. This may be achieved by using a medium with multiple gratings or a medium with a fan-shaped grating structure, and then tuning by translating the medium laterally to the laser beam in the plane of the grating. Thus in this case the wavelength may be selected by translating the laser beam laterally to the laser beam so that the laser beam is exposed to a grating structure in the nonlinear material corresponding to the desired wavelength of output laser light. In this case the tuner may comprise a mechanical translator, for translating the nonlinear material laterally to the laser beam. The wavelength shifted laser light beam generated by the nonlinear material may then be outputted from the cavity using the output coupler.

### Cavity Configuration

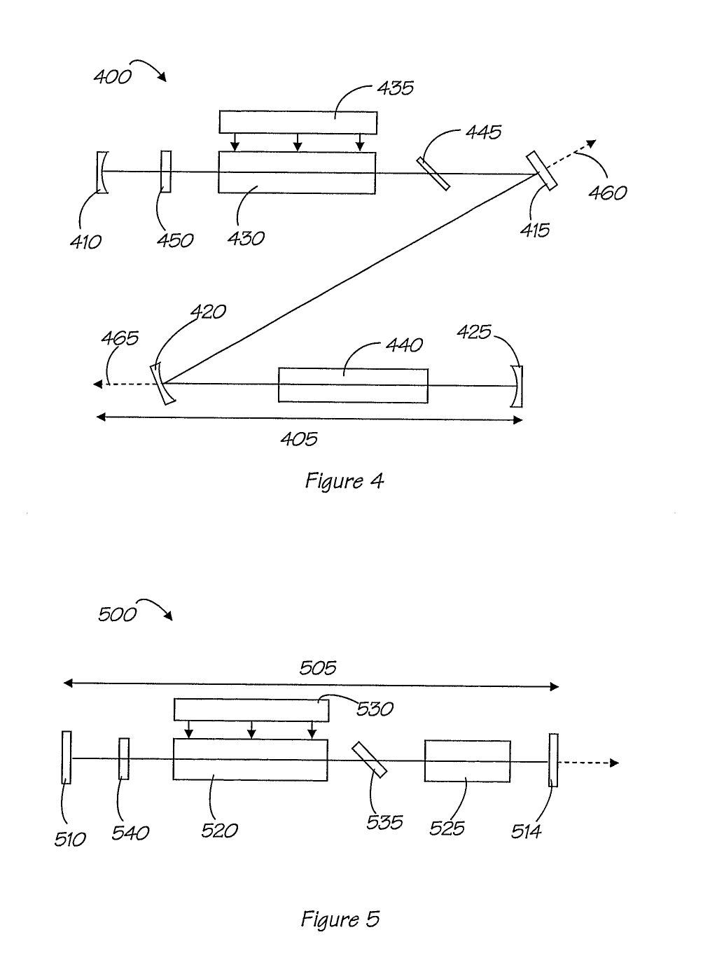

An example arrangement of a cavity configuration of a laser system is shown in FIG. 4. Laser 400 comprises a Z-shaped resonator cavity 405 defined by reflectors 410, 415, 420 and 425. Reflectors 410, 415, 420 and 425 are highly reflective at the wavelengths generated by laser crystal 430. Laser crystal 430, for example Nd:YAG, is disposed in resonator cavity 405 between reflectors 410 and 415 and is capable of being side pumped by flashlamp pump 435 in order to generate laser light at a plurality of fundamental wavelengths which can circulate in resonator cavity 405. One of reflectors 415, 420 and 425 is highly transmissive towards the wavelengths of laser light generated by non-linear crystal 440, and can therefore act as an output coupler, and the other two of these reflectors are highly reflective towards those wavelengths. Brewster plate 445 acts as a polariser, and quarter wave plate 450, located between laser medium 430 and reflector is 410, acts as a compensator for compensating for thermal depolarisation of laser light within laser medium 430 as it heats during operation of laser 400. The axis of quarter wave plate 450 should be aligned with Brewster plate 445, however once the alignment has been set, no further adjustments need be made to their relative orientations during operation of the laser. Non-linear crystal 440 may be for example LBO, and is type I phase matched so as to perform a conversion of the plurality of fundamental wavelengths simultaneously to create the converted wavelength output laser light.

In operation, flashlamp pump 435 is used to pump laser medium 430, causing laser medium 430 to generate a cavity laser beam having plurality of wavelengths which resonates in cavity 405. In doing so, the cavity laser beam is reflected from reflectors 415 and 420, which direct it to nonlinear crystal 440. Brewster plate 445 polarises the cavity laser beam, so that the beam resonating in cavity 405 will be polarised. Heating of laser crystal 430 due to operation of the laser may cause some loss of polarisation of the cavity laser beam, and this is compensated by compensation element 450, for compensating for thermal depolarisation of laser light (caused by thermally induced stree birefringence) within the laser medium and to ensure that the cavity laser beam remains polarised. The compensation element may be in the present discussion may be a quarter-wave plate, a half-wave plate, or some other birefringent compensator, or an alternative compensator such as a porro prism or a combination of a birefringent waveplate and a porro prism, or an optical rotator for example a Faraday rotator. There are many methods available for provide for compensation of thermally induced stress birefringence. As stated above, the compensator may consist of waveplate, optical rotator or a Faraday rotator but the preferred arrangement depends on the type of reflectors used in the resonator cavity. Note that a Faraday rotator has B-field applied along the axis and the rotation sense depends on the propagation direction, unlike an optical rotator for which the rotation sense is direction independent. When using a normal reflector, a waveplate or a Faraday rotator are often used. When using a Porro prism as a reflector, which has the advantage that alignment is more stable, a waveplate or an optical rotator is often used. A normal reflector and an optical rotator may also be capable of sufficiently compensating for the thermally induced depolarisation in some arrangements.

The cavity laser beam is converted by nonlinear crystal 440 into a converted laser beam by a frequency doubling process. The converted laser beam has a polarisation orthogonal to the unconverted cavity laser beam. The converted laser beam is coupled out of cavity 405 through reflector 415, 420 or 425. Thus if reflector 415 is highly transmissive to the frequency doubled wavelengths (and consequently reflectors 420 and 425 are highly reflective to the frequency doubled wavelengths) then the frequency doubled wavelengths will be coupled out of cavity 405 through output coupler 415 as output laser beam 460. Alternatively, if reflector 420 is highly transmissive to the frequency doubled wavelengths (and consequently reflector 425 is highly reflective to the frequency doubled wavelengths) then the frequency doubled wavelengths will be coupled out of cavity 405 through output coupler 420 as output laser beam 465.

Another example of a cavity configuration is shown in FIG. 5. Laser 500 comprises resonator cavity 505 defined by first reflector 510 and second reflector 515. Reflector 510 is highly reflective for all wavelengths that resonate in the cavity and reflector 515 is highly reflective for the fundamental wavelengths of laser light generated by laser crystal 520 and highly transmissive for the wavelengths of laser light that have been produced by nonlinear crystal 525 by wavelength conversion of the fundamental wavelengths. Laser crystal 520 is disposed in resonator cavity 505 and flashlamp 530 is provided for side pumping laser medium 520 in order to generate laser light at a plurality of fundamental wavelengths which can circulate in resonator cavity 505. Brewster plate 535 is disposed within the resonator cavity for polarising the laser light, and quarter wave plate 540 is located between laser medium 520 and reflector 510, and acts as a compensator for compensating for thermal depolarisation of the laser light within laser medium 520 as it heats during operation of the laser. The axis of quarter wave plate 540 should be aligned with Brewster plate 535, however once the alignment has been set, no further adjustments need be made to their relative orientations during operation of the laser. Nonlinear crystal 525, e.g. LBO, is located in resonator cavity 505 and is type I phase matched so as to perform a conversion of the plurality of fundamental wavelengths simultaneously to create the converted wavelength output laser light.

In operation, flashlamp pump 530 is used to pump laser crystal 520, causing laser crystal 520 to generate a cavity laser beam having plurality of fundamental wavelengths which resonates in cavity 505. In general, one of the plurality of fundamental wavelengths will be a desired wavelength at which the laser is configured to operate. The other fundamental wavelengths generated by the laser crystal may be unwanted or parasitic fundamental wavelengths at which operation of the laser at those wavelengths is undesired. The cavity laser beam passes through Brewster plate 535, which polarises the cavity laser beam, so that the beam resonating in cavity 505 is polarised. Heating of laser medium 520 due to operation of the laser may cause some loss of polarisation of the cavity laser beam, and this is compensated by quarter wave plate 540, to ensure that the cavity laser beam remains polarised. The cavity laser beam is converted by nonlinear crystal 525 into a converted laser beam by a frequency doubling process. Nonlinear crystal 525 maybe tuned (angle tuned or temperature tuned) to optimal frequency doubling of a desired one of the plurality of fundamental wavelengths using a tuner (not shown) to generate a converted laser beam. Depending on the type of phase matching of the nonlinear crystal, the converted laser beam may have a polarisation orthogonal to the unconverted cavity laser beam. The converted laser beam is then outputted from cavity 505 through reflector 515 performing as an output coupler.

The nonlinear coefficient at the parasitic wavelengths may provide enough loss on these transitions to either convert or suppress them almost completely. For example, the non-linear loss may be sufficient to keep the parasitic transitions from lasing altogether. This is evident in the case of 1064, 1061, 1074 nm, where 1064 nm (highest gain, highest non linear loss), 1074 nm (lowest gain of the three, small non linear loss, as it is in the wings of the phase matching curve), but we do not see 1061 nm or its harmonic (second highest gain, high non linear loss). Therefore, the non-linear loss and intrinsic gain of the transitions combine to determine if the parasitic transition will lase. So sometimes the nonlinear loss is enough to substantially diminish a parasitic transition. Note that there may be some 1061 nm and harmonics, but it was too small for us to detect. 1074 nm was detected easily, even though it was 5 orders of magnitude below the 1064 nm magnitude.

It will be appreciated by the skilled addressee that the above discussion regarding laser systems having multiple transitions which may lase at parasitic wavelengths is equally applicable to laser systems having broad transitions from tunable materials such as those observed from the chromium, titanium, erbium and ytterbium, holmium, thulium, nickel, cobalt, vanadium and cerium ions. These free running transitions are usually on the order of a nm to several nm, which is too broad for a nonlinear material such as KTP, or a similar nonlinear medium having only a narrow nonlinear phase matching bandwidth, to convert or partially convert all wavelengths to the second harmonic. If such a nonlinear medium were used with the broad lasing transition of the tunable laser material, the laser wavelengths not falling within the wavelength acceptance may become preferentially amplified to very high levels and ultimately cause damage to the resonator optics (i.e. the components of the laser). In contrast, nonlinear media having a broad phase matching bandwidth may convert the full width of the transition as well as providing nonlinear loss to surrounding wavelengths, which helps to prevent laser oscillation of any parasitic wavelengths (i.e., wavelengths that fall outside the acceptance range) in the laser system and thus avoiding damage to the laser.

In general, the arrangements of the laser system described herein provide techniques for operating a laser system which may operate on a plurality of fundamental laser wavelengths (due to either multiple laser emission transitions in the gain material or where the gain material has a broadband tunable emission transition) instead of just a single desired fundamental wavelength. The fundamental laser wavelengths other than the desired fundamental wavelength are generally termed as parasitic wavelengths and are usually unwanted as they have the potential to build up enough power in the laser cavity to cause damage to the optical components (e.g. the laser medium and/or the nonlinear material and/or the reflectors or mirrors of the cavity, and/or any other optical elements located in the cavity for example etalons, prisms, polarisers, depolarisers, q-switches, modelockers, lenses, gratings, beamsplitters etc) of the laser system. The arrangements describe the use of a nonlinear material which is optimally phase matched for nonlinear frequency conversion of the single desired fundamental wavelength and at least partially (or sub-optimally) phasematched for nonlinear frequency conversion of the other parasitic or unwanted fundamental wavelengths. Ensuring that the nonlinear material is at least partially phase matched for nonlinear frequency conversion of these parasitic fundamental laser wavelengths provides an additional loss mechanism in the laser cavity at the wavelength of those transitions, and ensures that the parasitic fundamental laser wavelengths do not build up sufficient optical power in the laser cavity to cause damage to the laser components.

For example, the desired fundamental laser wavelength of a laser system may have a wavelength of λ1. The laser gain material may also be able to generate a second fundamental laser wavelength with a wavelength of λ₂. The desired output wavelength of the laser system is the nonlinear frequency converted wavelength of λ₁, which has a wavelength of λ₃, therefore a nonlinear material is placed in the cavity of the laser system and the phase matching of the nonlinear material configured (or possibly tuned in the case of a tunable nonlinear material) for optimal frequency conversion of the desired fundamental wavelength λ₁ to the desired frequency converted wavelength λ₃. To restrict the gain of the laser system so that the parasitic laser wavelength, λ₂, is not able to acquire enough optical power to cause damage to the laser components, the nonlinear crystal is configured such that, whilst remaining optimally phasematched for nonlinear conversion of λ₁, it is also simultaneously at least partially phasematched for nonlinear frequency conversion of λ₂. The nonlinear material may be sub-optimally phasematched for nonlinear frequency conversion of λ₂. In this configuration, at least a portion of the optical power in the laser cavity at the parasitic wavelength λ₂ is nonlinear frequency converted and thereby limiting the optical intracavity power in the laser system of the parasitic laser wavelength λ₂. In this manner the optical power in the cavity at λ₂ may be restricted to below the power levels at which damage to the components of the laser system may occur. It will be appreciated that this technique is not limited to the conversion of only one parasitic laser wavelength in the laser cavity in addition to conversion of the desired fundamental wavelength. In other arrangements as described herein, the nonlinear material of the laser system is configurable for at least partial phase matching of a plurality of parasitic laser frequencies (eg. 2, 3, 4, 5, 6, 7, 8, 9, 10 or more). It may be suboptimal phasematched to the plurality of parasitic frequencies In some arrangements, the nonlinear material may be configured such that the parasitic laser wavelengths are phasematched within the primary wavelength or angular acceptance bandwidth of the phase matching curve (i.e. the central lobe 1 of the nonlinear coupling efficiency curve as shown in FIG. 1A) of the nonlinear material, but the laser system may also be configured such that the parasitic laser wavelength is partially phase matched such that it coincides with a secondary lobe (eg. 2 or 3 of FIG. 1A) of the nonlinear coupling efficiency relationship of the nonlinear material. For the case of a tunable gain material, λ₁ may be the desired laser peak emission wavelength of the tunable gain bandwidth, and λ₂ may be another wavelength in the tunable bandwidth where the laser crystal and resonator combination observes laser gain, such that stimulated laser emission could occur at this wavelength. In this case, the nonlinear material may be optimally phase matched to λ₁ and also sub-optimally phase matched to λ₂, such that at least a portion of the optical power in the laser cavity at the parasitic wavelength λ₂ is nonlinear frequency converted, thereby limiting the optical intracavity power in the laser system of the parasitic laser wavelength λ₂.

### Use of the Laser

A further aspect of the present laser systems includes a method of using laser light for treating, detecting or diagnosing a selected area requiring such diagnosis or treatment on or in a subject comprising illuminating the selected area with the output laser beam of the arrangements described herein. The selected area may be illuminated with a laser beam having a wavelength for a time and at a power level which is appropriate and effective for the diagnosis or therapeutically effective for the treatment. The subject may be a mammal or vertebrate or other animal or insect, or fish. The subject may be a mammal or vertebrate which is a bovine, human, ovine, equine, caprine, leporine, feline or canine vertebrate. Advantageously the vertebrate is a bovine, human, ovine, equine, caprine, leporine, domestic fowl, feline or canine vertebrate. The method finds particular application in treating the eyes and skin of a mammal or vertebrate, i.e. in opthalmology and dermatology.

Arrangements of the laser system may also be used in connection with holograms, in diagnostic applications (for example in displays, fluorescence detection, cell separation, cell counting, imaging applications), military systems (e.g. for military countermeasures, underwater systems, communication, illumination, ranging, depth sounding, mapping contours such as a sea floor), opthalmology, urology, surgery (e.g. vascular surgery) for purposes including cutting, coagulation, vaporization, destruction of tissue etc., stimulation, photodynamic therapy etc., gas detection, treatment of skin disorders e.g. psoriasis. It may be used in dermatological applications such as treatment of spider veins, or treatment of acne, skin rejuvenation or treatment of hypopigmentation due to sun damage. The laser may be used in combination with other therapies, for example treatment with drugs, creams, lotions, ointments etc. (e.g. steroids), optically clearing agents, other device based therapies etc.

A further aspect of the present laser systems includes a method for displaying laser light on a selected area comprising illuminating the selected area with the output laser beam of the arrangements described herein. The method may also comprise use of an aim beam in order to aim the output laser beam towards the selected area. The aim beam may have a wavelength in the visible range. Accordingly, the laser system may also comprise a source of the aim beam, which may be a diode laser, an LED or some other suitable source. A mirror, which may be a dichroic mirror, may also be provided in order to direct the aim beam in the same direction as the output laser beam.

It is well-known that visible light, in particular green/yellow and red light can be used to target a variety of chromophores present in human or animal tissue. These chromophores include melanin, haemoglobin, collagen-related constituents and also porphyrin, which is present for example at bacteria sites associated with acne.

As a consequence, green, yellow and red light can be used to treat a wide variety of medical conditions and to perform a variety of cosmetic procedures. Many of these treatments involve eye and skin, and examples include retinal procedures, treatment of vascular and pigmented lesions, collagen rejuvenation, wound and scar healing and acne treatment.

In addition to the natural chromophores listed above, special dyes may be incorporated into body tissues, which react with certain components of body tissue when activated by particular wavelengths of light. This process is called photodynamic therapy, and is being used increasingly to treat a range of medical disorders ranging from cancer to skin and eye disorders.

In using a laser to provide any of the treatments above, there is an optimum wavelength of the laser light which provides the best clinical effectiveness with fewest side effects. This optimum wavelength depends on the condition being treated, the chromophore being targeted and the characteristics of the surrounding tissues (eg. skin type).

The laser described herein has the ability to be made compact and portable.

The table below summarises the applications to which the arrangements of the present laser system may be applied, together with the wavelengths suitable for those applications.

| | Green (nom. | Yellow (nom. | Red (nom. 621, |
|---|---|---|---|
| Conditions treated | 532 nm | 579 or 588) | 635 or 660 nm) |
| Tattoo removal | ✓ | ✓ | ✓ |
| Hair removal | | | |
| Skin rejuvenation/ | ✓ | ✓ | ✓(?) |
| Tightening | | | |
| Vascular lesions/rosacea/ | ✓ | ✓ | ✓(?) |
| Port wine stains | | | |
| Leg vein (varicose) removal | ✓ | ✓ | ✓(?) |
| Pigmented lesions | ✓ | ✓ | ✓(?) |
| Scars/keloids | | ✓ | ✓(?) |
| Cellulite removal | ✓ | ✓ | ✓ |
| Psoriasis/Vitiligo | | ✓ | |
| Autoimmune disease/eczema | | | |
| Acne | ✓ | ✓ | ✓ |
| Actinic Keratoses/Skin cancer | | | |
| Photodynamic therapy | ✓ | ✓ | ✓ |
| Other medical procedures, e.g. benign | | | |
| prostate hyperplasia, atrial fibrillation, | ✓ | ✓ | ✓ |
| ophthalmology, clot removal, removal | | | |
| (vaporization) of tissue | | | |

The symbol √(?) in the above table indicates that the indication is likely but not certain. For tattoo removal it is preferable that the laser system be Q switched. Likewise a number of pigmented lesion applications may require a Q switched laser.

The arrangements of the laser system provide a laser system and/or methods to treat any of the above conditions by using a single wavelength or multiple wavelengths in the order and spaced by time that is matched to a patient's clinical status. Alternatively, multiple wavelengths may be applied to a patient concurrently e.g. as the IR and visible lasers may come from separate rods it is possible to apply IR and visible together or spaced by a time factor selected by the clinician from a range offered by the apparatus. Thus it may be possible to house more than one, e.g. 2, 3 or more than 3, laser systems according to the presently described arrangements in the one housing or box in order to provide the concurrent multiple wavelengths. Using the technology described in this specification, a laser system may be constructed that provides more than one, e.g. 2, 3 or more than 3, visible output frequency simultaneously.

### EXAMPLES

### Example 1

### Green Generation

The present example demonstrates generation of visible green laser output using simultaneous doubling, mixing of several laser lines generated simultaneously in a flashlamp pumped Nd:YAG laser material, which are then subsequently mixed in a single nonlinear LBO crystal. The Nd:YAG crystal was a 6 mm diameter laser rod with a length of 110 mm, and the dimensions of the LBO nonlinear crystal were 4×4×15 mm.

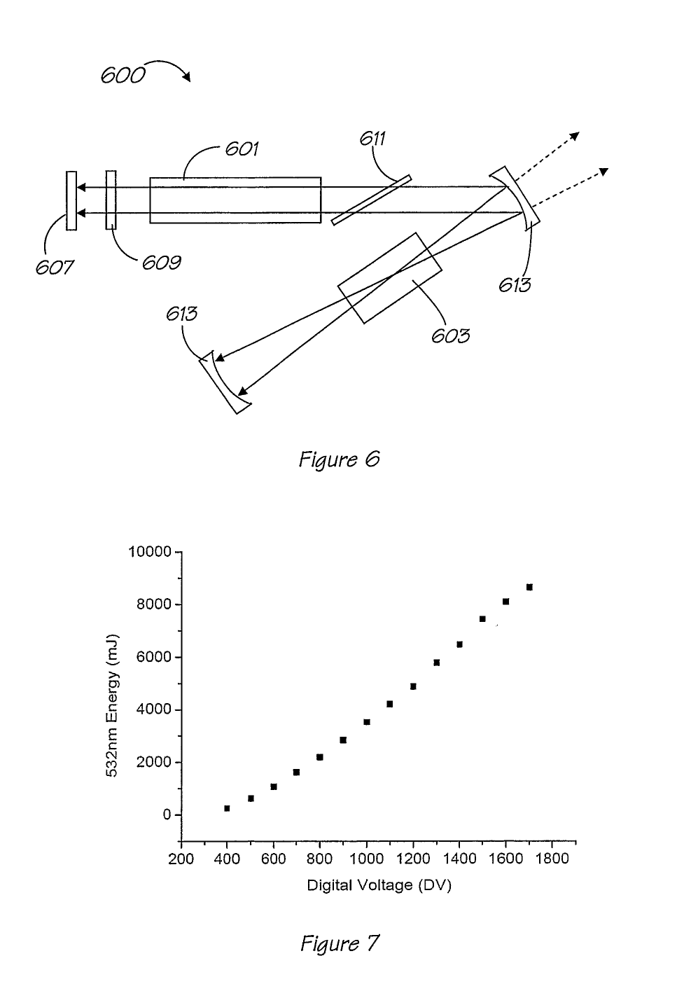

The laser 600 shown in FIG. 6 was constructed, with the Nd:YAG laser material 601 and the nonlinear LBO crystal 603 positioned in two arms of the folded laser cavity of resonator 600. End mirror 607 was highly reflective (R>99.9%) at a wavelength of 1064 nm corresponding to the peak laser transition of Nd: YAG. A quarter wave plate (of quarter-wave thickness at 1064 nm) 609 was inserted in the cavity to helps to rotate unwanted polarisations (which occur due to thermal depolarisation) back on to the principle polarisation plane (which is determined by the orientation of the polariser). Because the quarter wave plate is oriented with the polariser (i.e. Brewster plate 611), the principal radiation is left unaffected. The Brewster plate 611 was used to ensure the fundamental laser beams are polarised. Turning mirror 613 had a radius of curvature of 50 cm concave and was highly reflective (HR) for the wavelength range of 1030 to 1090 nm, and approximately 90% transmissive in the range 530 to 540 nm so that turning mirror 613 also acted as the output coupler for the green frequency converted output. End mirror 615 had a radius of curvature of 20 cm concave and was highly reflective at 1064 nm. The nonlinear LBO crystal 603 was cut for theta=85.4 degrees, phi=0 degrees.

For efficient operation of the laser, the distance between the tuning mirror 613 and the end of the LBO crystal 603 was approximately 205 mm, and the distance between the end mirror 615 and the end of the LBO crystal 603 was approximately 170 mm. It will be appreciated, however, that these distances are subject to normal tolerances of approximately +/−10 mm and are also dependent upon the thermal lenses generated in the laser material 601 and the nonlinear material 603 which is dependent on the intracavity power of the laser.

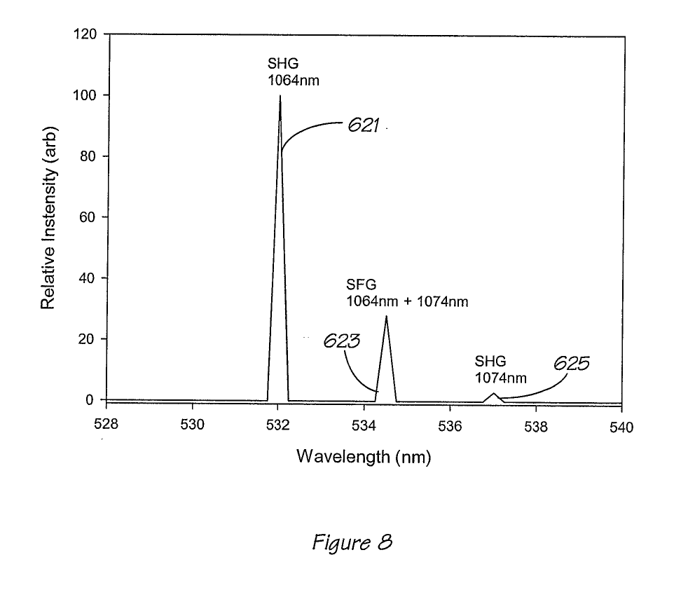

In operation, the laser 600 produced 8.6 J of green output in a 50 msec pulse train, and the output energy characteristics are shown in FIG. 7 as a function of the discharge voltage of the flashlamp pump source (not shown). The discharge voltage is presented in a 12-bit digital representation where 4095 digital volts (DV) represents the maximum flashlamp discharge voltage of 2500V. Conversion of the DV to actual voltage (V) is obtained by the relation: DV=V×(2500/4095). The voltage can then be converted into energy units (E) in Joules using the formula: E=0.5×C×V², where C is capacitance. In the present arrangement the capacitance C was 800 μF. This output consisted of three lines with wavelengths of 532, 534.5 and 537 nm as shown in the output spectrum shown in FIG. 8 (621, 623, and 625 respectively). These three output lines correspond to the second harmonic of 1064 nm (621 of FIG. 8), the sum frequency mix of 1064 nm and 1074 nm radiation (623 of FIG. 8), and the second harmonic of the 1074 mm parasitic laser line (625 of FIG. 8).

The output spectrum is shown in FIG. 8 was obtained by relaying the output on to an optical spectrometer. The output spectrum was measured by first dispersing the output using a 1200 nm line grating before imaging the output near 537 nm onto the slit of a 0.25 m grating spectrometer and in turn this output into a second-grating spectrometer. This was necessary in order to reduce the scatter of 532 nm radiation, which formed a large background signal to the much weaker emission at the longer wavelengths.

### Example 2

### Red Generation

The present example demonstrates generation of visible red laser output using simultaneous doubling, mixing of several laser lines generated simultaneously in a flashlamp pumped Nd:YAG laser material, which are then subsequently mixed in a single nonlinear LBO crystal. The Nd:YAG crystal was a 6 mm diameter laser rod with a length of 110 mm, and the dimensions of the LBO nonlinear crystal were 4×4×15 mm.

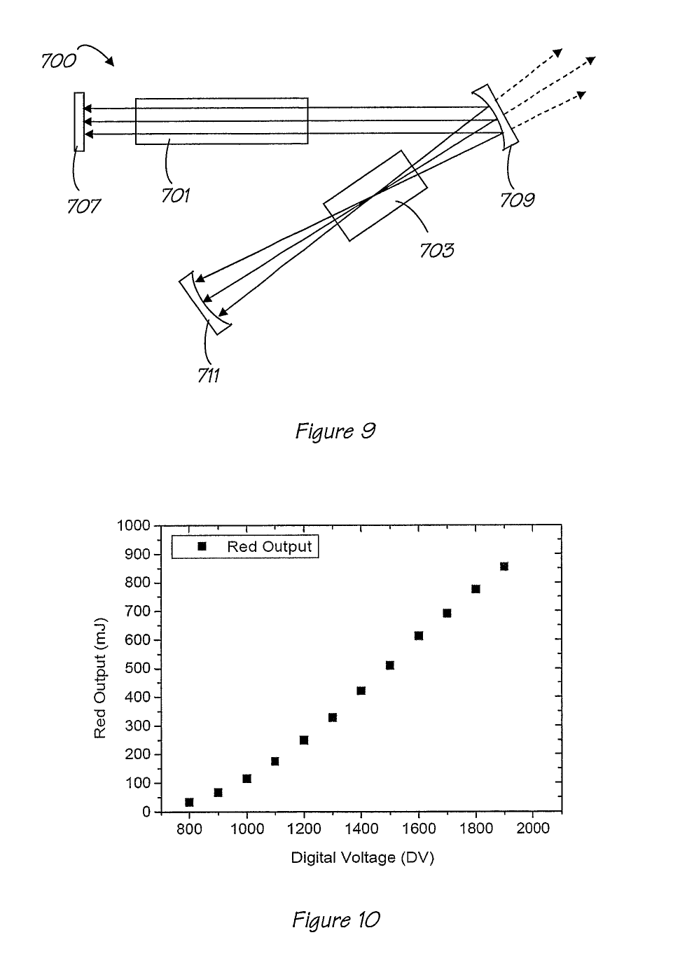

The laser 700 shown in FIG. 9 was constructed, with the Nd:YAG laser material 701 and the nonlinear LBO crystal 703 positioned in two arms of the folded laser cavity of resonator 700. End mirror 707 was highly reflective (R>99.9%) at a wavelength of 1340 nm and highly transmissive (R<1%) at a wavelength of 1064 nm. Turning mirror 709 had a radius of curvature of 50 cm concave and was highly reflective (HR) for at wavelengths of 1064, 1319 and 1338 nm, and was approximately 80% transmissive in the range at a wavelength of about 660 nm so that turning mirror 709 also acted as the output coupler for the red frequency converted output. End mirror 711 had a radius of curvature of about 15 cm concave and was highly reflective at 1064, 1319, and 1338 nm, and was also approximately 80% transmissive in the range at about 660 nm. The nonlinear LBO crystal 703 was cut for theta=85.4 degrees, phi=0 degrees.

For efficient operation of the laser the distance between the tuning mirror 709 and the end of the LBO crystal 703 was approximately 240 mm, and the distance between the end mirror 711 and the end of the LBO crystal 703 was approximately 120 mm. Again, it will be appreciated, however, that these distances are subject to normal tolerances of approximately +/−10 nm and are also dependent upon the thermal lenses generated in the laser material 601 and the nonlinear material 603 which is dependent on the intracavity power of the laser.

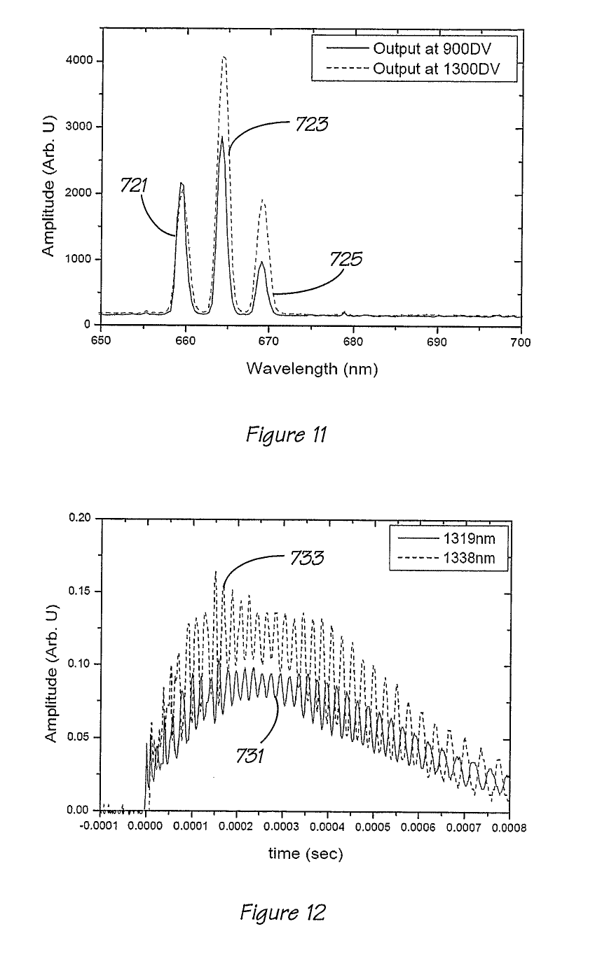

In operation, the laser 700 produced approximately 0.860 J of red output in a 10 msec pulse train, and the output energy characteristics are shown in FIG. 10. The output consisted of three lines, 660, 665 and 669 nm as shown in the output spectrum shown in FIG. 11 (721, 723, and 725 respectively). These three output lines correspond to the second harmonic of 1319 nm (721 of FIG. 10), the sum frequency mix of 1319 nm and 1338 nm radiation (723 of FIG. 10), and the second harmonic of 1338 nm (725 of FIG. 10). Two traces (dotted and solid traces of FIG. 10) are shown for laser operation at two power levels as a function of the discharge voltage of the flashlamp pump source (not shown) in digital volts (DV) (as above).

Additionally a temporal trace of the two 1.3 μm lines 1319 and 1338 nm is shown FIG. 12 (731 and 733 respectively). In this configuration the two laser transitions oscillate out of phase, which is due variation of the non-linear coupling with intensity.

The resonator used in this example was limited by existing LBO coating damage and it understood that it may be considerably further increased than presently demonstrated.

It will be appreciated that the laser systems, apparatus, and methods of operating a laser system described in the above description and examples and/or illustrated in the figures above at least substantially provide a for generating visible output with high energy and a method for operating the laser at such high energy and high average power without causing damage to components of the laser.

The laser systems, apparatus, and methods of operating a laser system described herein, and/or shown in the drawings, are presented by way of example only and are not limiting as to the scope of the invention. Unless otherwise specifically stated, individual aspects and components of the laser systems and/or methods may be modified, or may have been substituted therefore known equivalents, or as yet unknown substitutes such as may be developed in the future or such as may be found to be acceptable substitutes in the future. The laser systems and/or methods may also be modified for a variety of applications while remaining within the scope and spirit of the claimed invention, since the range of potential applications is great, and since it is intended that the present laser systems and/or methods be adaptable to many such variations.

1.-63. (canceled)

64. A laser comprising:
a resonator cavity defined by at least two reflectors, wherein the at least two reflectors are highly reflective at a plurality of fundamental wavelengths;
a laser medium disposed in the resonator cavity capable of generating the plurality of fundamental wavelengths;
an optical pump source for energizing the laser medium, thereby causing laser light at the plurality of fundamental wavelengths to resonate in the resonator cavity simultaneously; and
a nonlinear material located in the resonator cavity capable of simultaneously converting each of the plurality of wavelengths of laser light to generate converted laser light having a plurality of converted wavelengths, the converted wavelengths being derived from, but different than the fundamental wavelengths;
an output coupler disposed so as to output the converted laser light as output laser light
wherein the non-linear material is at least partially phase matched for simultaneous nonlinear conversion of the frequencies of each of the fundamental wavelengths.

65. The laser of claim 64, wherein the phase matching of each of the fundamental wavelengths that resonate within the cavity is sufficient that the conversion by the nonlinear material is such that none of the fundamental wavelengths can build up within the cavity to a level at which damage is caused to a component of the laser.

66. The laser of claim 64, wherein at least one of the reflectors is transmissive at fundamental wavelengths of laser light that are not converted by the nonlinear material so that those fundamental wavelengths do not resonate within the cavity.

67. The laser of claim 64, further comprising a compensator located in the resonator cavity for reducing thermally induced depolarisation of the laser light.

68. The laser of claim 67, wherein the compensator is selected from the group of a birefringent waveplate comprising either a quarter-wave plate or a half-wave plate, optical rotator a faraday rotator, or a porro-prism in combination with either a birefringent waveplate or an optical rotator.

69. The laser of claim 64, further comprising a polariser located in the resonator cavity for polarising the laser light resonating in the cavity.

70. The laser of claim 64, wherein the laser is a pulsed laser, quasi-cw, cw, q-switched, modelocked or the laser output is a burst of a plurality of laser pulses.

71. The laser of claim 70, wherein the bursts are repeated at a burst-repetition rate between about 0.1 Hz and about 20 Hz.

72. The laser of claim 70, wherein the laser energy in each burst of output pulses is either greater than 3 Joules or greater than 5 Joules and the duration of each burst of output pulses either between 1 and 200 milliseconds, between 1 and 100 milliseconds, between about 1 and 50 milliseconds, less than 100 milliseconds, greater than 3 milliseconds.

73. The laser of claim 64, wherein the laser material is a solid state laser material comprising a neodymium active ion for generation of the plurality of fundamental wavelengths.

74. The laser of claim 73, wherein the laser material is selected from the group of Nd:YAP, Nd:YLF, Nd:YAG, Nd:GdVO₄ and Nd:YVO₄.

75. The laser of claim 64, wherein the nonlinear material is selected from the group of LBO, BBO, KTP, CLBO, DLAP, ADP, periodically poled lithium niobate, periodically poled KTP, periodically poled KTA, and periodically poled RTA.

76. The laser of claim 64, wherein the laser material is Nd:YAG and the nonlinear material is LBO.

77. The laser of claim 64, wherein the laser material is a solid state material comprising an active ion for generation of the plurality of fundamental wavelengths, wherein the active ion has a continuously tunable emission transition.

78. The laser of claim 77, wherein the active ion is selected from the group of chromium, titanium, erbium, holmium, thulium, nickel, cobalt, vanadium, cerium and ytterbium.

79. The laser of claim 64, wherein output coupler is transmissive at least at a wavelength of 532 nm and the output laser light is substantially at a wavelength of 532 nm or the output coupler is transmissive at least at a wavelength of 660 to 670 nm and the output laser light is substantially comprised of light at wavelengths of 660 nm, 665 nm and 670 nm.

80. The laser of claim 64, further comprising a tuner for tuning the nonlinear material so as to be capable of converting the plurality of wavelengths of the laser light to generate output laser light having the converted wavelength of laser light.

81. The laser of claim 64, further comprising a third reflector located in the resonator cavity, wherein the resonator cavity is a folded resonator cavity and the third reflector is a folding reflector being an output coupler for outputting at least one of the converted wavelengths.

82. A laser comprising:
a resonator cavity defined by at least two reflectors, wherein the at least two reflectors are highly reflective at a plurality of fundamental wavelengths;
a laser medium disposed in the resonator cavity capable of generating plurality of polarised beams at the fundamental wavelengths;
an optical pump source for energizing the laser medium, thereby causing laser light at the plurality of fundamental wavelengths to resonate in the resonator cavity simultaneously;
a nonlinear material located in the resonator cavity capable of simultaneously converting each of the plurality of wavelengths of laser light to generate converted laser light having a plurality of converted wavelengths, the converted wavelengths being derived from, but different than the fundamental wavelengths; and
a polarisation compensation element located in the resonator cavity for depolarisation compensation of the polarised beams due to thermal heating of either the laser medium or the nonlinear medium.

83. The laser of claim 82, wherein the compensator is selected from the group of a quarter-wave plate, a half-wave plate, or some other birefringent waveplate, a faraday rotator or a porro-prism in combination with either a birefringent waveplate or an optical rotator.

84. A laser comprising:
a resonator cavity defined by at least two reflectors, wherein the at least two reflectors are highly reflective at a plurality of fundamental wavelengths;
a laser medium disposed in the resonator cavity capable of generating plurality fundamental wavelengths;
an optical pump source for energizing the laser medium, thereby causing laser light at the plurality of fundamental wavelengths to resonate in the resonator cavity simultaneously; and
a nonlinear material located in the resonator cavity capable of simultaneously converting each of the plurality of wavelengths of laser light to generate converted laser light having a plurality of converted wavelengths, the converted wavelengths being derived from, but different than the fundamental wavelengths;
wherein the nonlinear medium is capable of either frequency converting the plurality of fundamental wavelengths or providing sufficient loss at the fundamental wavelengths to prevent unwanted fundamental wavelengths from oscillating in the resonator cavity.

85. A method for providing laser light comprising:
providing a laser as claimed in claim 64;
causing the optical pump to energise the laser medium, thereby causing laser light at a plurality of fundamental wavelengths to circulate in the resonator cavity;
allowing the nonlinear material to simultaneously convert the plurality of wavelengths of the laser light to create output laser light having the converted wavelengths; and
outputting the output laser light from the laser.

86. The method of claim 85, additionally comprising tuning the nonlinear material so as to be capable of converting the plurality of wavelengths of the laser light to create the output light having a plurality of converted wavelengths of laser light, the converted wavelengths being different from the fundamental wavelengths.

87. The method of claim 85, comprising polarising the laser light circulating in the resonator cavity.

88. The method of claim 85, additionally comprising compensation for thermally-induced depolarisation of the laser light using a compensator.

89. The method of claim 85, wherein the plurality of fundamental wavelengths comprises a primary fundamental wavelength and at least one parasitic fundamental wavelength and the phase matching of each of the fundamental wavelengths that resonate within the cavity is sufficient that the conversion by the nonlinear material is such that the parasitic fundamental wavelengths can not build up within the cavity to a level at which damage is caused to a component of the laser.

90. The method of claim 85, wherein at least one of the reflectors is transmissive at fundamental wavelengths of laser light that are not converted by the nonlinear material so that those fundamental wavelengths do not resonate within the cavity.

91. A method of using a laser as claimed in claim 64, for treating, detecting or diagnosing a selected area on or in a subject requiring such diagnosis or treatment, the method comprising illuminating the selected area with output light from the laser.

92. A method as claimed in claim 91, for treating a skin condition selected from the group of tattoo removal or reduction, hair removal or reduction, skin rejuvenation, skin tightening, treatment of vascular lesions, rosacea, removal of port wine stains, varicose vein removal, removal of pigmented lesions, removal or reduction of scars or keloids, cellulite removal or reduction, psoriasis, vitiligo, autoimmune disease, eczema, acne, actinic keratoses, skin cancer benign prostate hyperplasia, atrial fibrillation, opthalmology, clot removal, and removal (vaporization) of tissue.
